(19) United States
(12) Patent Application Publication
(10) Pub. No.: US 2026/0241954 A1
(43) Pub. Date: Aug. 20, 2026

(54) SURFACE SENSING

(71) Applicant: NVIDIA CORPORATION, Santa Clara, CA (US)

(72) Inventors: Elad Plaut, Santa Clara, CA (US); Andreas Klaus, Graz (AT); Gerald Schweighofer, Blaindorf (AT); Samuel Rupp Ogden, Duvall, WA (US); Joachim Bauer, Graz (AT); Joachim PEHSERL, Lynnwood, WA (US); Zhiding Yu, Cupertino, CA (US); Prasanna Kumar Sivakumar, Pittsburgh, PA (US)

(21) Appl. No.: 19/646,941

(22) Filed: Apr. 14, 2026

Related U.S. Application Data
(62) Division of application No. 18/825,137, filed on Sep. 5, 2024.
(60) Provisional application No. 63/631,449, filed on Apr. 8, 2024.

(51) Int. Cl. B60W 60/00; G01S 17/89; G06V 10/80; G06V 10/82

(52) U.S. Cl. CPC B60W 60/001; G01S 17/89; G06V 10/806; G06V 10/82; B60W 2420/408; B60W 2552/15; B60W 2556/35

(57) ABSTRACT

Embodiments relate to hazard detection in autonomous and semi-autonomous systems and applications. A transformer may use sampled image and LiDAR features to extract and decode a representation of one or more features of each point (e.g., refined height, range, driving condition, etc.) on a sampled surface (e.g., the road). These detections may be provided to one or more control components of an autonomous vehicle, which may use the detections to navigate, plan, or otherwise perform one or more operations. Some embodiments employ an automated approach to derive ground truth data from sensor data collected by data collection vehicle(s), such as data representing detected ground surface models, detected surface features, detected weather and/or surface condition labels, and/or detected per-point artifact labels. Accordingly, surface features such as ground surface heights along a predicted trajectory may be detected and ground truth data may be generated for a variety of sensing tasks.

### CROSS-REFERENCE TO RELATED APPLICATIONS

This application is a divisional of U.S. application Ser. No. 18/825,137 filed on Sep. 5, 2024, which claims priority to U.S. Provisional Application No. 63/631,449, filed on Apr. 8, 2024. The contents of each of the foregoing applications are hereby incorporated by reference in their entirety.

### BACKGROUND

Designing a system to drive a vehicle autonomously, safely, and comfortably without supervision is tremendously difficult. An autonomous vehicle should at least be capable of performing as a functional equivalent of an attentive driver—who draws upon a perception and action system that has an incredible ability to identify and react to dynamic and static hazards in a complex environment—to navigate along the path of the vehicle through the surrounding three-dimensional (3D) environment. As such, the ability to detect hazards and road surface profiles is often critical for autonomous driving perception systems. For example, an estimated ground surface profile may be used for many important tasks, such as estimating a navigable space (e.g., the road surface), facilitating the detection of static obstacles on the road surface, adjusting suspension or other components for a smoother ride, and/or estimating the height of static obstacles. Hazard detection may seek to identify potential threats such as dynamic obstacles (e.g., other vehicles, pedestrians, animals) or static obstacles (e.g., road debris, construction barriers, road signs, traffic cones, curbs, guardrails, etc.). These techniques may rely on sensor data from cameras, LiDAR, RADAR, or ultrasonic sensors to provide a comprehensive and real-time understanding of the vehicle's surroundings.

Detecting hazards and road surface profiles at far distances is particularly challenging due to the inherent limitations of current sensor technologies. LiDAR, which uses laser pulses to create detailed 3D representations of the environment, often provides good accuracy at close range but produces sparse data points at greater distances, which may be further limited by weather conditions (e.g., resulting in few or even no measurements on wet roads), leading to incomplete and less reliable representations. On the other hand, RADAR, which uses radio waves to detect objects and measure distances, can operate effectively over long ranges and in various weather conditions, but its resolution is lower, making it difficult to precisely identify and classify distant hazards. Camera-only solutions offer high-resolution visual data, capturing detailed images of the surroundings. However, these solutions struggle with accurately determining the distance to objects, especially objects that are far away. Depth perception with cameras relies on visual cues and complex algorithms, which can be unreliable and/or computationally intensive. Moreover, cameras are often sensitive to lighting conditions, such as glare from the sun or poor visibility in low light, further complicating the task of detecting and assessing distant hazards.

As such, there is a need for improved hazard detection and surface sensing techniques.

### SUMMARY

Embodiments of the present disclosure relate to hazard detection and surface sensing in autonomous and semi-autonomous systems and applications. Systems and methods are disclosed that detect and navigate (e.g., road) surfaces, detect and avoid hazards, and/or generate corresponding ground truth data for various detection networks or other machine learning models, such as those used by autonomous vehicles, semi-autonomous vehicles, robots, and/or other object or machine types.

Taking hazard detection as an example, a transformer may use sampled image and LiDAR features to extract and decode a representation of whether there is a hazard at the 3D location corresponding to each initial transformer query, the shape of the hazard, and/or its class. For each initial query, an output layer of the transformer may regress a representation of a two-dimensional (2D) or 3D bounding box (or other bounding shape) anchored at a corresponding 3D location and predicted to contain a detected hazard, may regress a representation of uncertainty in the regressed bounding shape, and/or may classify the detected hazard into any number of supported classes (e.g., generating corresponding class confidence scores, such as a binary classification score indicating whether there is road debris predicted at the corresponding 3D location). These detections may be provided to one or more control components of an autonomous vehicle, which may use the detections to navigate, plan, or otherwise perform one or more operations (e.g., obstacle avoidance, lane keeping, lane changing, merging, splitting, etc.).

Additionally or alternatively, a transformer may be used to generate a representation of one or more features of a designated portion of a (e.g., road or other navigable) surface. For example, a desired surface (e.g., the road) may be modeled using a set of sampled 3D points (e.g., along one or more 2D trajectories of the ego-machine), and the transformer may use sampled image and LiDAR features to extract and decode a representation of one or more features of each point (e.g., refined height, range, driving condition, etc.). For example, an output layer of the transformer may regress a representation of a refined height value at the 3D location corresponding to each initial transformer query, may regress a representation of uncertainty in the regressed height value, may regress a representation of the driving condition at that point (e.g., quantifying impairment to the surface caused by a detected surface or weather condition), and/or may classify the point into any number of supported classes (e.g., generating corresponding class confidence scores). These detections may be provided to one or more control components of an autonomous vehicle, which may use the detections to navigate, plan, or otherwise perform one or more operations (e.g., obstacle or protuberance avoidance, lane keeping, lane changing, merging, splitting, adapting a suspension system of the ego-object or ego-actor to match the current road surface, applying an early acceleration or deceleration based on an approaching surface slope, mapping, etc.) within an environment.

In some embodiments, ground truth data for training a neural network and/or for parameter tuning of a classical machine learning model that detects objects and/or surface features may be generated in various ways. For example, some embodiments may employ an automated approach (e.g., using classical, non-machine learned algorithms) to derive various types of ground truth data from sensor data collected by one or more data collection vehicles, such as data representing detected dynamic obstacles, a detected ground surface model, detected surface features, detected static scene points, a detected navigable space boundary, detected hazard objects, detected non-static scene points, detected weather and/or surface condition labels, and/or detected per-point artifact labels.

Accordingly, the techniques described herein may be used to detect hazards such as road debris and other obstacles, detect surface features such as ground surface heights along a predicted trajectory, and/or generate ground truth data for a variety of autonomous vehicle and/or other sensing tasks.

### BRIEF DESCRIPTION OF THE DRAWINGS

The present systems and methods for hazard detection and surface sensing in autonomous and semi-autonomous systems and applications are described in detail below with reference to the attached drawing figures, wherein:

FIG. 1 is a data flow diagram illustrating an example object detection pipeline, in accordance with some embodiments of the present disclosure;

FIG. 2 illustrates example height profile of a road surface, in accordance with some embodiments of the present disclosure;

FIG. 3 is a data flow diagram illustrating an example surface feature detection pipeline, in accordance with some embodiments of the present disclosure;

FIG. 4 is a data flow diagram illustrating an example ground truth data generation pipeline in accordance with some embodiments of the present disclosure;

FIG. 5 is an illustration of an example ground surface model, in accordance with some embodiments of the present disclosure;

FIG. 6 illustrates an example technique for sampling from a ground surface model, in accordance with some embodiments of the present disclosure;

FIG. 7 is an illustration of an example boundary of a navigable space, in accordance with some embodiments of the present disclosure;

FIG. 8 is an illustration of an example navigable space and example extracted road hazards, in accordance with some embodiments of the present disclosure;

FIG. 9 is a flow diagram illustrating a method for hazard detection, in accordance with some embodiments of the present disclosure;

FIG. 10 is a flow diagram illustrating a method for generating a ground truth representation of one or more static hazards, in accordance with some embodiments of the present disclosure;

FIG. 11 is a flow diagram illustrating a method for surface feature detection, in accordance with some embodiments of the present disclosure;

FIG. 12 is a flow diagram illustrating a method for generating a ground truth representation of one or more features of a detected ground surface, in accordance with some embodiments of the present disclosure;

FIG. 13A is an illustration of an example autonomous vehicle, in accordance with some embodiments of the present disclosure;

FIG. 13B is an example of camera locations and fields of view for the example autonomous vehicle of FIG. 13A, in accordance with some embodiments of the present disclosure;

FIG. 13C is a block diagram of an example system architecture for the example autonomous vehicle of FIG. 13A, in accordance with some embodiments of the present disclosure;

FIG. 13D is a system diagram for communication between cloud-based server(s) and the example autonomous vehicle of FIG. 13A, in accordance with some embodiments of the present disclosure;

FIG. 14 is a block diagram of an example computing device suitable for use in implementing some embodiments of the present disclosure; and

FIG. 15 is a block diagram of an example data center suitable for use in implementing some embodiments of the present disclosure.

### DETAILED DESCRIPTION

Systems and methods are disclosed related to hazard detection and surface sensing in autonomous and semi-autonomous systems and applications. The present techniques may be used to detect and navigate (e.g., road, drivable, navigable, etc.) surfaces, detect and avoid hazards, and/or generate corresponding ground truth data for various detection networks or other machine learning models, such as those used by autonomous vehicles, semi-autonomous vehicles, robots, and/or other object or machine types.

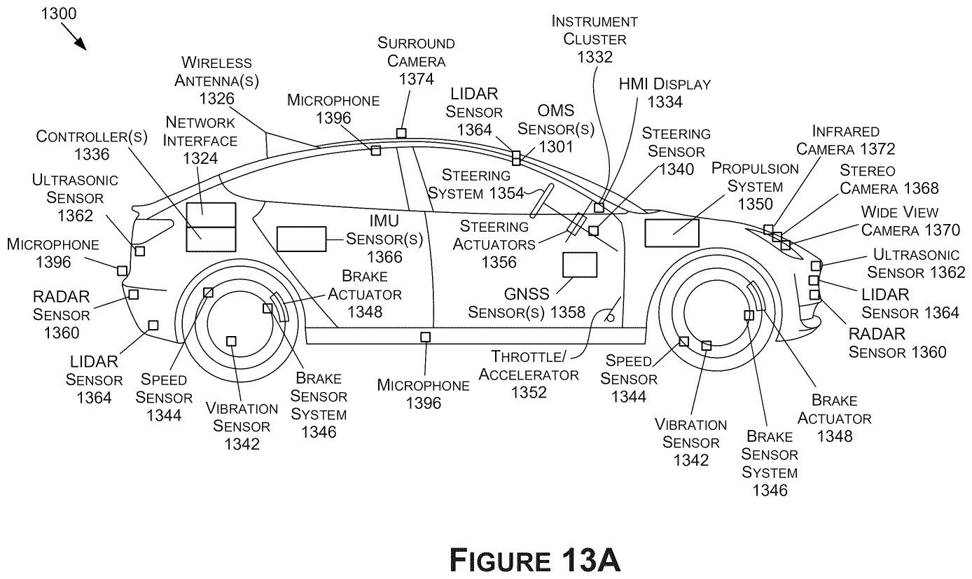

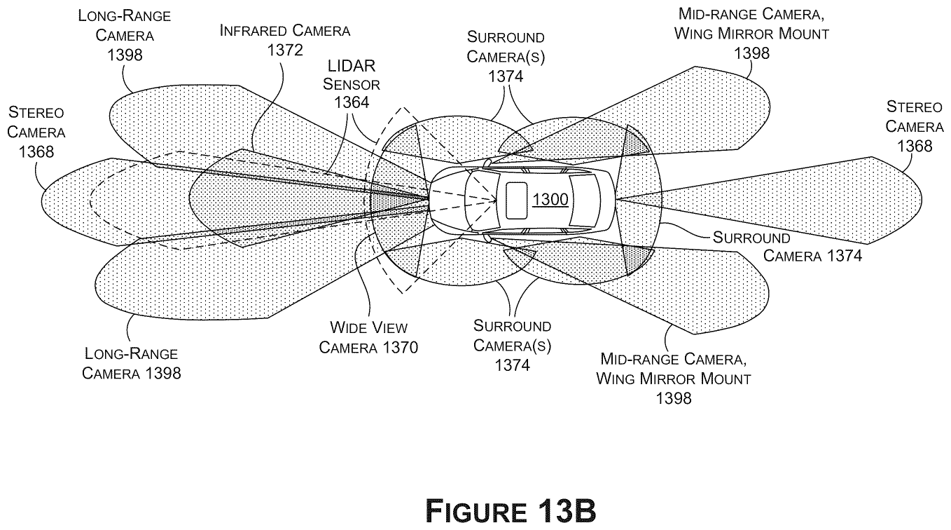

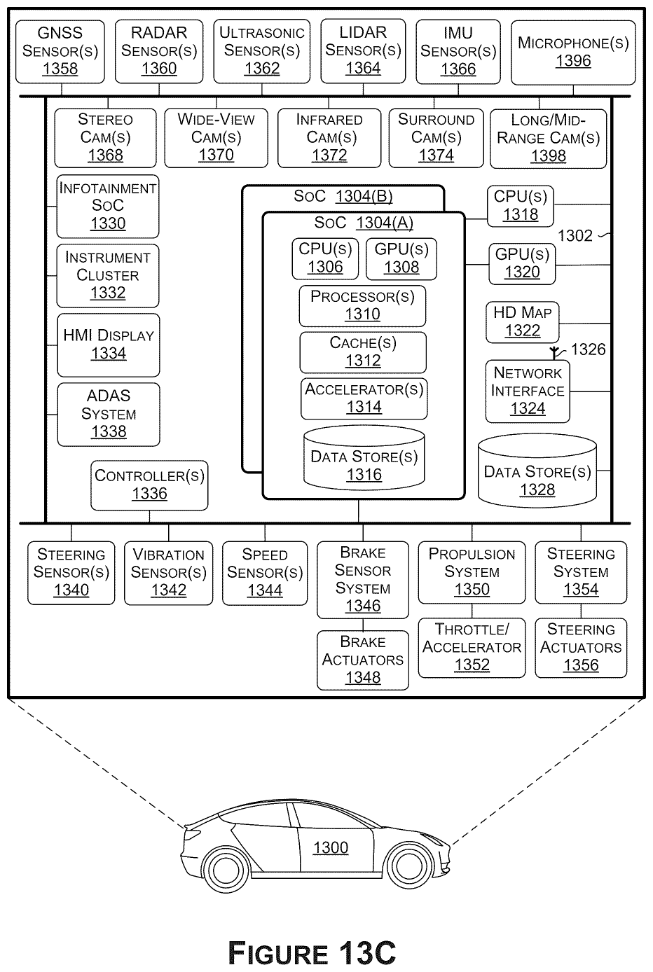

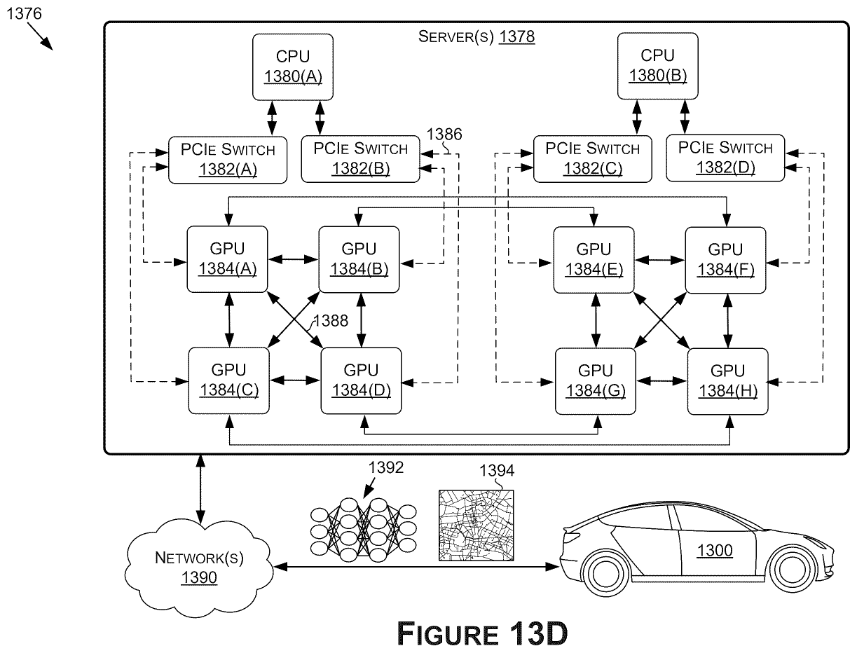

Although the present disclosure may be described with respect to an example autonomous or semi-autonomous vehicle or machine 1300 (alternatively referred to herein as “vehicle 1300” or “ego-machine 1300,” an example of which is described with respect to FIGS. 13A-13D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to hazard detection or surface sensing for autonomous or semi-autonomous systems and applications, this is not intended to be limiting, and the systems and methods described herein may be used in augmented reality, virtual reality, mixed reality, robotics, security and surveillance, autonomous or semi-autonomous machine applications, and/or any other technology spaces where object or surface detection may be used.

In some embodiments, an ego-machine may be equipped with one or more optical sensors (e.g., cameras) and one or more LiDAR sensors, the sensors may be used to generate corresponding image data and LiDAR data (e.g., while the ego-machine navigates through an environment), and one or more neural networks may use a transformer to fuse the image data and LiDAR data and detect hazards and/or one or more features of a (e.g., road or other navigable) surface in the environment.

Taking hazard detection as an example, initial queries comprising a set of reference or anchor 3D locations for the transformer may be identified using candidate bounding shapes predicted from extracted image features and/or extracted LiDAR features, randomly initialized 3D locations, and/or ego-motion compensated transformer predictions (e.g., for objects predicted with a threshold confidence) from a previous frame. Extracted image features (e.g., in perspective view) and extracted LiDAR features (e.g., in top-down or bird's eye view (BEV)) may be sampled around each 3D reference point at keypoint locations identified by projecting learned (e.g., deformable) and/or designated 2D or 3D offsets into corresponding feature maps, and the sampled image and LiDAR features may be fused in the cross-attention layer(s) of the transformer. As such, the transformer may use the sampled image and LiDAR features to extract and decode a representation of whether there is a hazard at the 3D location corresponding to each of the initial queries, its shape, and/or its class. For example, for the 3D reference point represented by each initial query, an output layer of the transformer may regress a representation of a two-dimensional (2D) or 3D bounding box (or other bounding shape) predicted to contain a detected object, may regress a representation of uncertainty in the regressed bounding shape, and/or may classify the detected object into any number of supported classes (e.g., generating corresponding class confidence scores, such as a binary classification score indicating whether there is road debris predicted at the corresponding 3D location).

Additionally or alternatively, the transformer may be used to generate a representation of one or more features of a designated portion of a (e.g., road or other navigable) surface. For example, a desired surface (e.g., the road) may be modeled using a set of sampled 3D points, and the transformer may be used to predict one or more features of each point (e.g., refined height, range, driving condition, etc.). In some embodiments, a 2D trajectory of the ego-machine (e.g., one or more tire trajectories) may be predicted (e.g., based on wheel angle), a set of 2D points may be sampled (e.g., logarithmically) along each trajectory, and an initial height (e.g., zero, in the rig coordinate system) may be assigned to generate a corresponding 3D reference point. As such, initial queries for the transformer may be identified using a set of sampled 3D reference points that model a designated portion of the surface and/or using ego-motion compensated transformer predictions (e.g., for sampled points predicted with a threshold confidence) from a previous frame. The transformer may use sampled image and LiDAR features to extract and decode a representation of one or more features of the surface at the 3D location corresponding to each of the initial queries. For example, for the 3D reference point represented by each initial query, an output layer of the transformer may regress a representation of a refined height value, may regress a representation of uncertainty in the regressed height value, may regress a representation of the driving condition at that point (e.g., quantifying impairment to the surface caused by a detected surface or weather condition), and/or may classify the point into any number of supported classes (e.g., generating corresponding class confidence scores).

In some embodiments that detect hazards and surface features, the hazards and surface features may be detected using separate neural networks, or the same multitask network with corresponding transformer input and output heads. In some embodiments that implement a multitask network, predicted uncertainties for the two tasks may be used as coefficients for summing their losses during training.

In some embodiments, ground truth data for a neural network that detects hazards and/or surface features, or that performs some other task, may be generated in various ways. For example, one or more data collection vehicles may be equipped with one or more LiDAR sensors (e.g., a single, roof-mounted, 360° field-of-view LiDAR scanner), and the LiDAR sensor(s) of the data collection vehicle(s) (and/or a stationary LiDAR sensor) may be used to collect frames of LiDAR data representing various hazards and/or surface conditions. The LiDAR data may be ego-motion compensated, any known technique may be used to detect and regress the shape of dynamic obstacles of any designated class represented in the LiDAR data, and the detected representation of the dynamic obstacles (e.g., 2D or 3D bounding boxes or other bounding shapes) may be used as ground truth data for dynamic obstacle detection tasks (e.g., in a hazard detection network that includes one or more auxiliary heads used to predict locations for initial transformer queries).

In some embodiments, detected LiDAR points that belong to dynamic obstacles may be removed, and (e.g., the resulting) point clouds from multiple frames may be registered to one another to increase point density and generate a refined ego-motion estimate (which supports an increased precision in downstream surface feature estimates). Any known technique may be used to estimate a representation of the ground surface based on LiDAR data (e.g., classifying and projecting points predicted to be on the ground surface onto a grid and smoothing projected values, etc.) and/or based on image data (e.g., using 3D reconstruction to generate an estimated representation of the ground surface), and the representation of the ground surface may be used as ground truth data for ground surface detection tasks. Taking an example embodiment involving a surface feature detection network that predicts feature(s) for a designated portion of a surface (e.g., a set of points sampled along one or more predicted trajectories), the designated portion of the surface may be sampled and used as ground truth. In some embodiments, any known smoothing technique may be applied to the designated portion of the surface (or some region that encompasses the designated portion, such as an area extending outward from the ego-machine along the surface) to refine the accuracy of the ground truth data.

In some embodiments, detected LiDAR points may be labeled as static or non-static based on consistency over multiple observations. For example, each frame (e.g., spin) of LiDAR data may be used to generate a projection image (e.g., a range image), a detected LiDAR point may be projected into the projection images for multiple frames, and a measure of consistency of presence and/or range may be used to classify the point as static or non-static. Generally, static objects should appear in some threshold number or percentage of frames or spins (e.g., at least 50% of the spins, accounting for occlusions), and the detected range to static objects should not change more than some threshold amount even as the sensor moves (e.g., the detected range should not double from frame to frame). In some embodiments, presence and/or range consistency may be quantified and used to derive a measure of consistency for each LiDAR point, points with a measure of consistency below a designated threshold may be classified as non-static (e.g., a non-static part of the scene), and points with a measure of consistency above a designated threshold may be classified as static (e.g., part of a static object or a static part of the scene).

In some embodiments, the points classified as static and the representation of the ground surface may be used to generate a representation of a navigable space (e.g., free space). The static points likely represent either the ground surface (in which case the height of the point represents the ground height) or a static hazard (in which case the height above ground may be derived from the height of the point and the estimated ground surface). In some embodiments, the representation of the ground surface encodes the ground height (or corresponding range) values. As such, the ground height may be subtracted from the height of each static point to derive the estimated height above ground for each static point. Furthermore, the ground surface may be represented as a grid with corresponding ground height or range values, and the ground height or range values may be used to derive and assign a corresponding surface curvature to each grid cell. As such, static points may be projected onto the grid, aggregated per cell, and compensated for noise, and an occupancy grid may be generated by evaluating the resulting height above ground and corresponding estimated surface curvature for each cell using any known height and curvature-based occupancy scoring function. The resulting occupancy scores may be segmented into binary values (e.g., classifying each grid cell as likely occupied or free space) using a global cost minimization technique, and any known technique may be used to extract enclosed 2D contours represented in the resulting binary segmentation map.

As such, the parent contour that encloses one or more sampled points associated with the trajectory of the ego-machine may be identified as a boundary of a navigable space (e.g., free space boundary) and may be used to derive ground truth data for any navigable or free space segmentation task. For example, the contour may be assigned corresponding estimated ground heights and projected into a corresponding view to generate the boundary for a ground truth segmentation mask. Extracted child contours of the parent contour may be assumed to represent static hazards, assigned corresponding heights, projected into the ground truth segmentation mask, and used to carve out regions from the ground truth navigable space. In some embodiments involving a hazard detection network that uses 3D reference points for initial transformer queries, (e.g., random) initial transformer queries that are located outside the ground truth navigable space may be omitted during training (e.g., to avoid training the network on regions predicted to be occupied with static hazards such as potholes or other surface deformities where automatically generated labels may not be reliable).

In some embodiments, extracted child contours of the parent contour that represents the predicted ground truth navigable space (e.g., detected contours inside the navigable space that are not part of the navigable space) may be used to identify ground truth static obstacles. Depending on the use case and/or the embodiment, extracted child contours that are longer than a designated length and/or that represent or enclose LiDAR points below the ground surface may be filtered out. The (e.g., remaining) child contours may be assumed to represent static obstacles, and 2D and/or 3D bounding boxes or other bounding shapes may be generated (e.g., using maximum and minimum heights of the LiDAR points enclosed by each contour). As such, the resulting representation of static obstacles may be used as ground truth data for any static obstacle detection task (e.g., in a hazard detection network).

In some embodiments that filter out points that belong to detected dynamic obstacles and identify the remaining non-static points in the scene, the non-static scene points are likely to belong to either weather or road conditions like rain or snow in the air or on the ground. As such, in some embodiments, to support weather condition detection tasks, a set of the non-static scene points may be sampled from a region that is unlikely to contain any obstacles, such as a cube (e.g., one meter in length) or other volume in front of the ego-machine and above the ground. The non-static scene points detected inside this region may be accumulated (e.g., over some designated duration or number of frames), and the power distribution of the resulting non-static scene points may be quantified across different frequency components (e.g., using a power spectrum analysis). As such, power levels at designated frequencies—or changes in power levels—may be assigned labels representing corresponding types of weather conditions (e.g., rain, snow, fog, dust, clear). Additionally or alternatively, a corresponding level of impairment to visibility may be classified (e.g., using a linear relationship between the number and/or power of non-static scene points and corresponding visibility impairment classes). To support driving condition detection tasks, a similar process may be used to identify and/or accumulate non-static scene points from a region on the ground surface (e.g., in front of the ego-machine), assign labels representing corresponding types of surface conditions (e.g., wet, snowy, icy, damp, dry), and/or assign labels representing corresponding levels of surface impairment. As such, the resulting weather and/or surface condition labels may be used as ground truth for any weather or road or pavement condition detection network.

Generally, artifacts such as particles in the ambient weather (e.g., snowflakes) or ephemeral events (e.g., condensate matter from vent plumes) can negatively impact the performance of time of flight sensors like LiDAR sensors, for example, by reducing the visibility of actual obstacles that the ego-machine should avoid, or by appearing like true obstacles that do need to be avoided. Accordingly, LiDAR points classified as part of the non-static scene and not part of a detected dynamic obstacle may be flagged as an artifact. In some embodiments, points that were identified as part of a dynamic object may be subtracted from points that were identified as non-static, and the remaining points may be labeled as artifacts. As such, the artifact labels may be used as ground truth for any artifact detection task.

Accordingly, the techniques described herein may be used to detect hazards such as road debris and other obstacles, detect surface features such as ground surface heights along a predicted trajectory, and/or generate ground truth data for a variety of autonomous vehicle and/or other sensing tasks. A representation of the detected hazards and/or surface features may be provided to an autonomous vehicle drive stack to enable safe and comfortable planning and control of the autonomous vehicle. For example, an autonomous vehicle may navigate the vehicle to avoid detected hazards on the road or detected protuberances (e.g., dips, holes) in the road, adapt the vehicle's suspension system to match a detected road profile (e.g., by compensating for bumps in the road), and/or apply an early acceleration or deceleration based on an approaching surface slope in a detected road profile. Any of these functions should serve to enhance safety, improve the longevity of the vehicle, improve energy-efficiency, and/or provide a smooth driving experience.

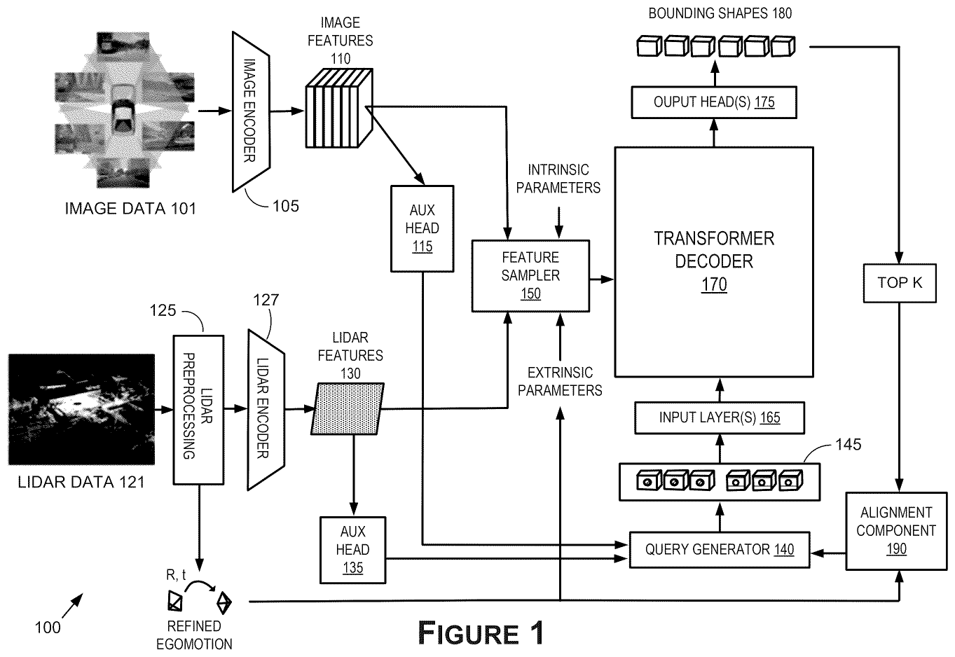

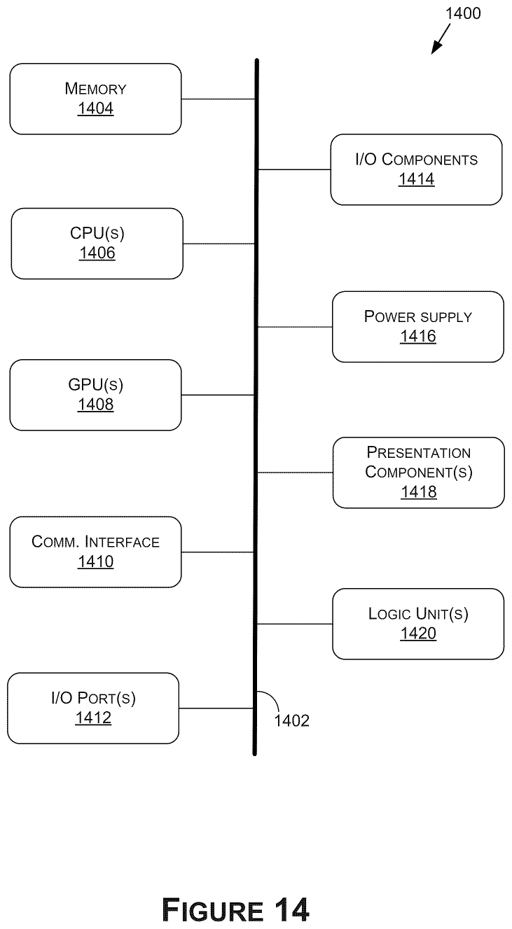

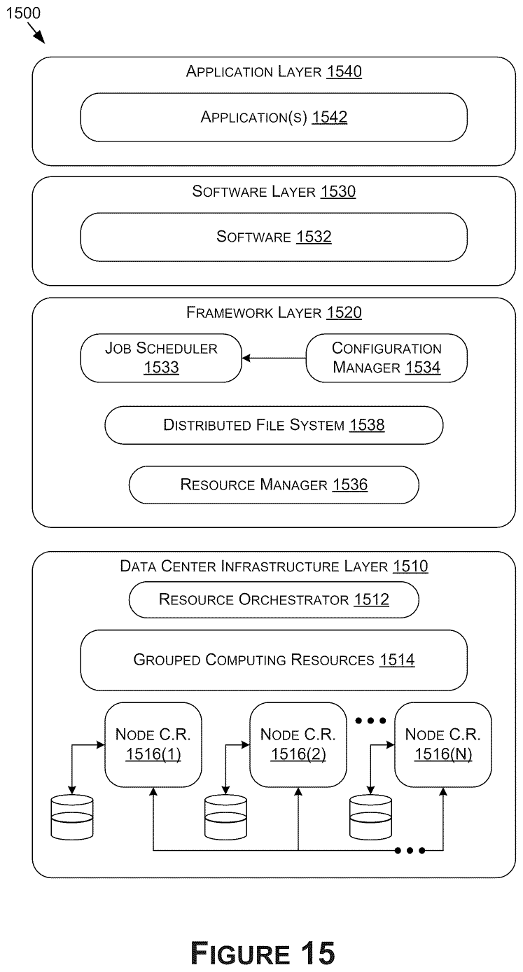

With reference to FIG. 1, FIG. 1 is an example object detection pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 1300 of FIGS. 13A-13D, example computing device 1400 of FIG. 14, and/or example data center 1500 of FIG. 15.

In the embodiment illustrated in FIG. 1, the object detection pipeline 100 uses image data 101 and LiDAR data 121 (e.g., generated using corresponding sensors of an ego-machine such as the autonomous vehicle 1300 of FIGS. 13A-13D) to detect bounding shapes 180 and/or other features of objects of one or more designated classes in the environment. More specifically, a query generator 140 may generate a set of object queries 145 comprising a set of reference or anchor 3D locations using candidate bounding shapes predicted from extracted image features 110 by an auxiliary head 115 and/or predicted from extracted LiDAR features 130 by an auxiliary head 135, using randomly initialized 3D locations, and/or using (e.g., the top K) ego-motion compensated transformer predictions (e.g., for objects predicted with a threshold confidence) from a previous frame. A feature sampler 150 may sample the image features 110 (e.g., in perspective view) and/or the LiDAR features 130 (e.g., in top-down or bird's eye view) around each 3D reference point at keypoint locations identified by projecting learned (e.g., deformable) and/or designated 2D or 3D offsets into corresponding feature maps, and a transformer (e.g., comprising input layer(s) 165, a transformer decoder 170, and one or more output head(s) 175) may use the sampled image and LiDAR features to extract a representation of whether there is an object (e.g., a hazard) at the 3D location corresponding to each of the object queries 145, its shape, and/or its class.

In some embodiments, an ego-machine (e.g., the autonomous vehicle 1300 of FIGS. 13A-13D) may be equipped with one or more optical sensors (e.g., cameras, such as the stereo camera(s) 1368, wide-view camera(s) 1370, infrared camera(s) 1372, surround camera(s) 1374, and/or long-range and/or mid-range camera(s) 1398 of FIG. 13A) and one or more LiDAR sensors (e.g., LiDAR sensor(s) 1364 of FIG. 13A), the optical and LiDAR sensors may be used to generate image data 101 and LiDAR data 121, respectively (e.g., while the ego-machine navigates through an environment), and the image data 101 and the LiDAR data 121 may be applied to corresponding input branches of the object detection pipeline 100. Sensor data from any given sensor may be generated at any frame rate, synchronized or otherwise associated with sensor data from other sensors, and processed by the object detection pipeline 100 at any frame rate. The sensor data from the different sensors may, but need, not be synchronized. For example, sensor data may be generated and/or aligned with respect to a common clock such that asynchronous sensor data from different sensors may be grouped together to represent a substantially common time slice. As such, the techniques described herein may be used with synchronous and/or asynchronous sensor data. The implementation illustrated in FIG. 1 is meant simply as an example, and other embodiments may additionally or alternatively include input branches for other types of sensor data, such as RADAR data, sonar data, depth data, and/or other types.

The image data 101 may include a frame from each of any number of optical sensors (e.g., cameras), and may be applied to (e.g., corresponding channels of) an image encoder 105 to extract image features 110 using any known technique. For example, the image encoder 105 may include any number of channels comprising one or more corresponding (e.g., neural network, convolutional neural network (CNN)) layers that extract (e.g., multiscale) image features from corresponding optical sensors (e.g., cameras). Hyperparameters such as kernel size, stride, channel count, and/or repetitions may be selected to balance accuracy and speed. The image encoder 105 may use upsampling to merge coarser feature maps with finer feature maps.

In some embodiments, the image features 110 are processed by an auxiliary head 115 to generate corresponding predictions (e.g., 2D or 3D object detections, dense depth), and the predictions may be used to generate the object queries 145 and/or to generate auxiliary losses to help train the image encoder 105. For example, the object queries 145 may include a set of initial 3D queries that represent positions and/or regions where the auxiliary head 115 predicts there may be objects, and the transformer may effectively refine these predictions. Depending on the implementation, the auxiliary head 115 may generate different types of predictions, which the query generator 140 may use to generate initial 3D queries for the transformer. For example, the auxiliary head 115 may generate (and the query generator 140 may decode) predictions such as 2D or 3D bounding boxes or other bounding shapes for one or more designated classes (which may correspond to the class(es) predicted by the transformer) and/or (e.g., dense) depth estimates. As such, the query generator 140 may use the predicted bounding shapes and/or corresponding depth estimates to generate one or more initial 3D queries.

For example, the query generator 140 may sample any number of 2D points (e.g., one representative 2D point such as the center point of each proposed 2D bounding shape) from one or more predicted 2D bounding shapes (e.g., the top M with the highest predicted confidence), and may sample any number of corresponding 3D points for a projected 3D representation of each sampled 2D point. For example, the query generator 140 may back-project the sampled 2D point into 3D using the corresponding (extrinsic and intrinsic) calibration parameters of a corresponding sensor, and sample (e.g., ten points) in 3D along a 3D ray that points from the origin (e.g., of the rig coordinate system) to the back-projected 3D location of the sampled 2D point. Additionally or alternatively, the query generator 140 may use predicted depth to estimate how far along the 3D space the detected object is, and may sample the 3D ray at one or more depths selected from a corresponding depth map at one or more pixels corresponding to one or more 2D points (e.g., the center point, one or more corners) from the predicted 2D bounding shape. In some embodiments, the auxiliary head 115 generates 3D bounding shapes, and the query generator 140 may sample one or more 3D points (e.g., a center 3D point) from one or more predicted 3D bounding shapes (e.g., the top M with the highest predicted confidence). These are just a few examples, and other ways of sampling from predicted 2D and/or 3D bounding shapes may be implemented within the scope of the present disclosure.

Returning to the LiDAR data 121, the LiDAR data 121 may include LiDAR detections from any number of LiDAR sensors and any number of spins or scans. In some embodiments, LiDAR processing 125 may be used to aggregate LiDAR data 121 from several spins or scans to create a more comprehensive and detailed LiDAR point cloud, estimate a refined ego-motion representing the ego-machine's trajectory, and use the refined ego-motion to ego-motion compensate and align the LiDAR data 121 in a common reference frame. As such, LiDAR data (e.g., LiDAR data 121, the aggregated and ego-motion compensated LiDAR data) may be applied to a LiDAR encoder 127 to extract LiDAR features 130 using any known technique, such as point cloud segmentation, projecting the 3D point cloud into a 2D view and then evaluating the resulting 2D projection image, or using mapping algorithm such as Simultaneous Localization and Mapping (SLAM). In an example embodiment, the LiDAR encoder 127 may discretize or bin LiDAR detections into columns or pillars corresponding to cells of a 2D grid, encode the point(s) in each column or pillar (e.g., using PointNet or a related architecture), populate the encoded features in corresponding cells of the 2D grid to generate a pseudo-image (e.g., in bird's eye view), and use one or more (e.g., neural network, such as CNN) layers to extract the LiDAR features 130 from the pseudo-image.

In some embodiments, the LiDAR features 130 may be processed by an auxiliary head 135 to generate corresponding predictions (e.g., 2D or 3D object detections), and the predictions may be used to generate the object queries 145 and/or to generate auxiliary losses to help train the LiDAR encoder 127. For example, the auxiliary head 135 may generate (and the query generator 140 may decode) predictions such as 2D or 3D bounding boxes or other bounding shapes for one or more designated classes (which may correspond to the class(es) predicted by the transformer), and the query generator 140 may use the predicted bounding shapes to generate one or more initial 3D queries. By way of nonlimiting example, the auxiliary head 135 may generate 3D bounding shapes (or 2D bounding shapes and height above ground, which may be used to generate 3D bounding shapes), and the query generator 140 may sample one or more 3D points (e.g., a center 3D point) from one or more predicted 3D bounding shapes (e.g., the top M with the highest predicted confidence).

In some embodiments, a transformer (e.g., comprising input layer(s) 165, a transformer decoder 170, and one or more output head(s) 175) may be used to generate a representation of whether there is an object (e.g., a hazard) at the 3D location corresponding to each of the object queries 145, its shape, and/or its class. Depending on the implementation, the query generator 140 may generate any number and type of transformer queries representing a set of reference or anchor 3D locations (e.g., candidate object positions). For example, the query generator 140 may identify the 3D locations for the object queries 145 using candidate bounding shapes predicted from the image features 110 by the auxiliary head 115 and/or predicted from the LiDAR features 130 by the auxiliary head 135, using randomly initialized 3D locations, and/or using (e.g., the top K) ego-motion compensated transformer predictions (e.g., for objects predicted with a threshold confidence) from a previous frame. By way of limiting example, the input layer(s) 165 of the transformer may accept a representation of 350 queries, which the query generator 140 may populate using 50 3D queries predicted by the transformer from the previous frame, 50 3D queries sampled from bounding shapes predicted from the image features 110, 50 3D queries sampled from bounding shapes predicted from the LiDAR features 130, and 200 randomly sampled 3D queries (e.g., selected from a uniform distribution). As such, the object queries 145 may be applied to the input layer(s) 165 of the transformer, which may transform the object queries 145 into corresponding embeddings (e.g., by projecting 3D coordinates into a higher-dimensional space that matches the input dimension expected by the transformer decoder 170, adding positional encodings to the embeddings to provide spatial or temporal context). As such, the object queries 145 may serve as candidate positions for the transformer to evaluate.

In some embodiments, instead of considering all possible combinations of query and image and LiDAR feature elements, which can be computationally expensive and inefficient for high-resolution inputs, the attention mechanism of the transformer decoder 170 may be focused on a subset of relevant positions sampled around the reference 3D location represented by each of the object queries 145. This sampling may be conceptualized as a set of offsets around the reference point, effectively deforming the grid of attention locations based on the (e.g., learned or fixed) offsets. As such, the transformer decoder 170 may compute attention weights for each of these sampled embeddings, where these weights determine how much influence each sampled point has on updating the representation of the object queries 145. Focusing on a sparse set of sampled points reduces the computational complexity compared to traditional dense attention mechanisms.

More specifically, the feature sampler 150 may sample the image features 110 (e.g., in perspective view) and/or the LiDAR features 130 (e.g., in top-down or bird's eye view) around the 3D reference point represented by each of the object queries 145 at keypoint locations identified by projecting learned (e.g., deformable) and/or designated 2D or 3D offsets into corresponding feature maps, and may apply the sampled features to the transformer decoder 170. Taking a query representing a reference 3D location as an example, the feature sampler 150 may project the reference 3D location into the 2D (e.g., perspective) view represented by the image features 110 using the corresponding intrinsic and extrinsic parameters for a corresponding optical sensor, and may project the reference 3D location into the 2D (e.g., top-down) view represented by the LiDAR features 130 using the corresponding intrinsic parameters and extrinsic parameters (e.g., updated to reflect the refined ego-motion) for a corresponding LiDAR sensor. In some embodiments, the feature sampler 150 may sample the features from the feature map extracted from the sensor data from each sensor at 2D keypoint locations identified by applying one or more 2D offsets to the projected 2D location in the corresponding extracted features. The 2D offsets may be learned or fixed, and may vary for each query, extracted feature map (e.g., corresponding to the different sensors), and/or attention head the sampled features are applied to. Additionally or alternatively, each 3D reference point represented by each of the object queries 145 may be associated with corresponding 3D keypoint locations (e.g., the center of each of the six faces of a corresponding 3D bounding box plus the center of the 3D bounding box) identified by applying one or more 3D offsets to the reference 3D location, and the feature sampler 150 may project the 3D keypoints into the extracted feature maps and sample the extracted feature maps at the projected locations. The 3D offsets may be learned or fixed, and may vary for each query, extracted feature map (e.g., corresponding to the different sensors), and/or attention head the sampled features are applied to. As such, the feature sampler 150 may sample any number of features from each extracted feature map (e.g., each channel of the image features 110, the LiDAR features 130) for each of the object queries 145 and/or each attention head of the transformer decoder 170.

As such, the transformer decoder 170 may use the encoded representation of the object queries 145 and the sampled image and LiDAR features to detect objects (e.g., predict the coordinates of bounding boxes or other bounding shapes 180 for each object). The transformer decoder 170 may include any number of transformer blocks, where each transformer block may include self-attention and cross-attention layers. Each self-attention layer may include any number of attention heads that compute attention scores representing the relationship between each query and every other query, and that convert these scores into attention weights (e.g., using a softmax function) that determine how much attention each query should pay to every other query. The attention weights may be used to create a weighted sum of the values associated with the queries, refining the representation of the object queries 145. In embodiments with multiple attention heads, each head may perform these operations independently, and the results may be concatenated and linearly transformed to generate the refined representation of the object queries 145. This self-attention mechanism allows the queries to share information with each other, helping the transformer understand global context and dependencies among the potential objects.

Each cross-attention layer may include any number of attention heads that compute attention scores representing the relationship between each query and each sampled feature embedding, and that convert these scores into attention weights (e.g., using a softmax function) that determine how much attention each query should pay to each sampled feature embedding. The attention weights may be used to create a weighted sum of the sampled feature embeddings, effectively fusing the sensor data from the different sensors and further refining the representation of the object queries 145 to represent a combination of each the object queries 145 with the sampled features. In embodiments with multiple attention heads, each head may perform these operations independently, and the results may be concatenated and linearly transformed to generate a combined representation of each the object queries 145 with the sampled features. This cross-attention mechanism allows the queries to integrate information from the sampled features, helping the transformer understand global context and dependencies among the potential objects.

As such, the transformer decoder 170 may include any number of transformer blocks that iteratively refine a combined representation of each the object queries 145 with the sampled features. For example, the transformer decoder 170 may output a vector for each object query, which may be applied to one or more output heads 175 (e.g., one for each of a plurality of designated classes) that regress a representation of a 2D or 3D bounding box or other bounding shape predicted to contain a detected object anchored at the 3D reference point represented by the object query, regress a representation of uncertainty in the regressed bounding shape, classify the detected object into any number of supported classes (e.g., generating corresponding class confidence scores, such as a binary classification score indicating whether there is road debris predicted at the corresponding 3D location).

In some embodiments, the output head(s) 175 include N channels (e.g., classifiers), where each channel regresses a representation of a particular aspect of the size, shape, or location of a detected object (e.g., from a particular class, for all classes, etc.), such as where the object is located relative to the 3D reference point (e.g., dx/dy vector pointing to a portion of the object such as the center or a corner), object height, object width, object orientation (e.g., rotation angle such as sine and/or cosine), some statistical measure thereof (e.g., minimum, maximum, mean, median, variance, etc.), uncertainty in one or more aspects of the regressed information, and/or the like. As such, the output head(s) 175 may serve to predict regression data representing a 2D or 3D bounding box or other bounding shape anchored at the 3D reference point represented by a corresponding object query.

Additionally or alternatively, the output head(s) 175 may include a channel (e.g., classifier) for each class of object to be detected (e.g., vehicles, cars, trucks, vulnerable road users, pedestrians, cyclists, motorbikes, static hazards such as road debris, some subclass thereof, etc.), where each channel performs one or more classifications (e.g., a classification score quantifying a likelihood that a designated class of object is located at the 3D reference point represented by a corresponding object query, a binary classification score, etc.).

In some embodiments, an alignment component 190 may identify a designated number of predictions (e.g., the top K with the highest predicted confidence) and add them to the object queries 145 for the next time step. For example, the output head(s) 175 of the transformer may generate a vector, tensor, or other data structure representing predicted parameters such as a classification score (e.g., for each of one or more classification channels) for each object query, and the alignment component 190 may read the classification scores for the object queries 145, identify a designated number of top scores, read and/or decode the predicted parameters representing the predicted location of the corresponding objects, use the refined ego-motion to update the predicted locations to reflect the current frame's ego-motion and align the predictions with the ego-machine's current position and orientation, and provide the updated locations to the query generator 140 to include in the object queries 145 for the next prediction.

As such, the transformer formed by the input layer(s) 165, the transformer decoder 170, and the output head(s) 175 may iteratively refine the object predictions. Each layer of the transformer may adjust the predicted positions and characteristics of the predicted objects based on the fused image and LiDAR features, improving the detection accuracy with each iteration. As such, the transformer may output a representation of the predicted locations, sizes, and/or classes of detected objects in the 3D environment. The object detections may be used by control component(s) of an autonomous vehicle, such as the controller(s) 1336, the ADAS system 1338, and/or an autonomous driving software stack (such as the one described in U.S. patent application Ser. No. 16/938,706, Publication No. 20210026355A1) executing on one or more components of the vehicle 1300 (e.g., the SoC(s) 1304, the CPU(s) 1318, the GPU(s) 1320, etc.). For example, the parameters predicted by the transformer may be decoded to generate 3D bounding boxes or other bounding shapes 180 and corresponding class labels and confidences, these object detections may be provided to the control component(s), and the control component(s) may use the object detections navigate, plan, or otherwise perform one or more operations (e.g., obstacle avoidance, lane keeping, lane changing, merging, splitting, etc.) within the environment using any known technique.

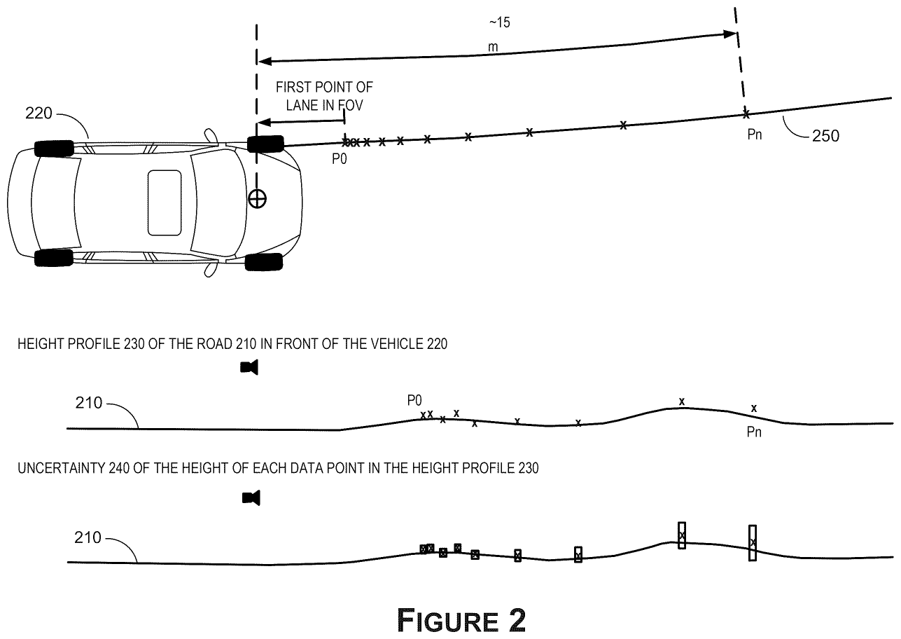

Furthermore, it is often useful (e.g., for an autonomous vehicle) to understand the height profile of the road or other surfaces. The height profile of the road or other navigable surface may provide information about height changes, slopes, and potential inclines or declines along the route, which may be used to optimize speed, braking, and acceleration. Furthermore, the vertical profile may be used to improve passenger comfort by anticipating and smoothly handling hilly or uneven terrains. FIG. 2 illustrates an example height profile 230 of a road surface, in accordance with some embodiments of the present disclosure. For example, as the vehicle 220 navigates the road 210, the height of the road 210 in front of the vehicle 220 may vary due to terrain features such as hills and valleys, expansion joints at bridges, step or milling edges at construction sites, potholes, lane grooves or ruts, speed bumps, cracks in the road surface, rough gravel surfaces resulting when the tarmac or smooth paved asphalt layer has been stripped away, joints between concrete slabs, or other curvature or damage to a road or other driving surface. As such, it may be useful to detect the height or other features (e.g., uncertainty 240 of the predicted height) of the road at one or more points in front of the vehicle, such as some number of points along a trajectory of the vehicle 220, such as the trajectory of one or more tires (e.g., trajectory 250).

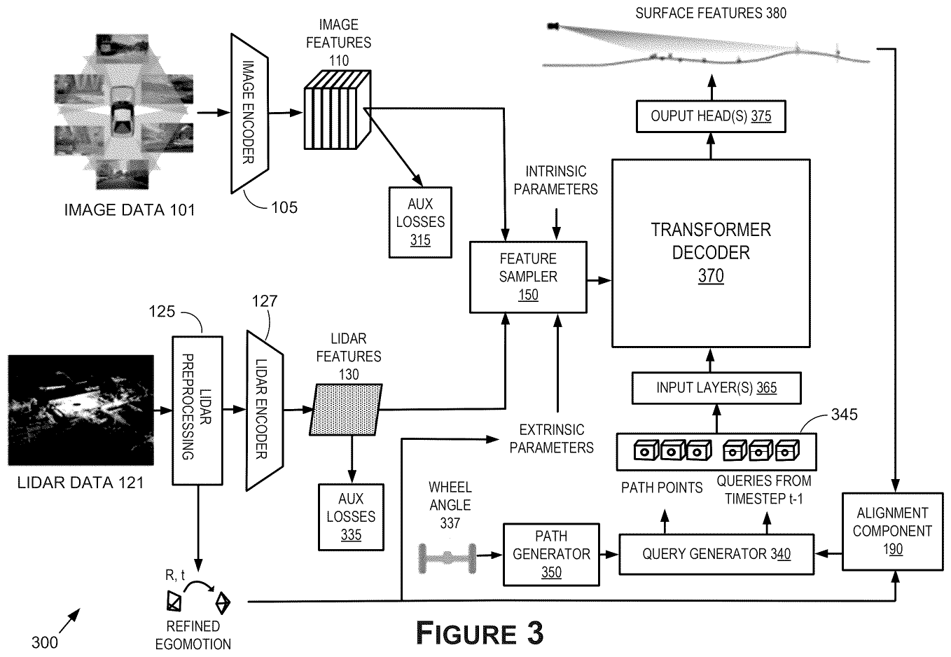

FIG. 3 is a data flow diagram illustrating an example surface feature detection pipeline 300 in accordance with some embodiments of the present disclosure. The components of the surface feature detection pipeline 300 that use similar numbering as corresponding components of the object detection pipeline 100 of FIG. 1 (e.g., the image encoder 105, the LiDAR encoder 127, the feature sampler 150) may have corresponding functionality. As such, a related architecture may be used to detect one or more features of the road or other surface in the environment. In the surface feature detection pipeline 300, the query generator 340 may generate a set of surface queries 345 using one or more trajectories of the ego-machine (e.g., one or more tire trajectories) predicted by a path generator 350 based on a corresponding wheel angle 337 and/or ego-motion compensated transformer predictions (e.g., for surface locations predicted with a threshold confidence) from a previous frame. As such, a transformer formed by input layer(s) 365, the transformer decoder 370, and one or more output heads 375 may use sampled image and LiDAR features to extract a representation of one or more surface features 380 (e.g., height, range, driving condition, etc.) at the 3D location corresponding to each of the surface queries, and surface queries 345 representing candidate 3D locations on the surface may be iteratively refined to detect one or more profiles of the surface.

Depending on the downstream use case, different surface features and different portions of the surface may be of interest. For example, some embodiments may seek to detect a representation of the height profile of the road or other surface along the tire tracks in front of a vehicle. Accordingly, the query generator 340 may sample any number of 2D or 3D points along a predicted trajectory (e.g., sampling 2D points along one or more tire trajectories in in bird's eye view and assigning a candidate height such as zero to each point). This is meant simply as an example, and other techniques for sampling candidate points for a road or other surface are possible (e.g., sampling a designated number of points from a designated plane such as z=0 or some other designated region of the environment).

Continuing with the example in which one or more 2D or 3D points are sampled along one or more predicted trajectories, the path generator 350 may identify the trajectories based on the wheel angle 337. For example, the path generator 350 may use the Ackermann steering model and the wheel angle 337 to generate a representation of the trajectory of one or more tires by simulating the vehicle's kinematic behavior based on its steering geometry. The Ackermann model defines a geometry that dictates how the wheels of a vehicle may be angled during a turn so the vehicle follows a smooth trajectory. Using this model, the inner and outer wheels of the vehicle should follow circular paths with different radii during a turn, centered on a common turning point. As such, the wheel angle 337 for the left and right tires may be detected using steering angle sensors and/or wheel position sensors, and the path generator 350 may use the wheel angle 337 for the left and right tires and the Ackermann model to calculate a representation of the predicted trajectory for each tire, such as the turning radius and curvature for each path in a 2D (e.g., top-down) view of the vehicle's movement plane (e.g., the x-y plane), assuming the road surface is flat. The query generator 340 may use the representation of each predicted trajectory to sample any number of 2D points (e.g., at regular intervals, logarithmically, etc.) along each trajectory (e.g., along the arc length extending from the front wheel to some designated distance such as 15 meters away) and assign an initial height (e.g., zero) to each 2D point to generate a corresponding candidate 3D location. As such, the query generator 340 may identify the surface queries 345 using a set of sampled 3D reference points that model a designated portion of the surface and/or using ego-motion compensated transformer predictions (e.g., for sampled points predicted with a threshold confidence) from a previous frame.

The transformer may use sampled image and LiDAR features to extract and decode a representation of the surface features 380 at the 3D location corresponding to each of the surface queries 345. The input layer(s) 365 and/or the transformer decoder 370 of the transformer of FIG. 3 may have similar functionality to the input layer(s) 165 and/or transformer decoder 170 of the transformer of FIG. 1, but may be adapted to the dimensionality of the surface queries 345. The output head(s) 375 may use the sampled image and LiDAR features to extract a representation of the surface features 380. For example, the transformer decoder 370 may output a vector for each surface query, and the vector for each surface query may be applied to one or more output heads 375 (e.g., one for each of a plurality of designated classes) that regress a representation of a refined height of the surface at the 3D location corresponding to the surface query, regress a representation of uncertainty in the regressed height, regress a representation of the driving condition at that 3D location (e.g., quantifying impairment to the surface caused by a detected surface or weather condition), and/or classify the point into any number of supported classes (e.g., generating corresponding class confidence scores).

In some embodiments, the output head(s) 375 include N channels (e.g., classifiers), where each channel regresses a representation of a particular feature of the surface at the 3D reference point requested by the surface query (e.g., height above the ground plane, range, a quantified representation of impairment to the surface caused by a detected surface or weather condition, skid resistance, surface gradient or curvature, etc.), uncertainty in one or more aspects of the regressed information, and/or the like. As such, the output head(s) 375 may serve to predict regression data representing one or more features of the surface at the 3D reference point represented by a corresponding surface query.

Additionally or alternatively, the output head(s) 375 may include a channel (e.g., classifier) for each class of surface feature to be detected (e.g., surface condition such as cracked, potholed, or smooth; presence of road markings; texture type such as grooved or rough; contamination type such as debris, water, or oil; and/or others), where each channel performs one or more classifications (e.g., a classification score quantifying a likelihood that a designated class of surface feature is located at the 3D location represented by a corresponding surface query, a binary classification score, etc.).

As such, the transformer formed by the input layer(s) 365, the transformer decoder 370, and the output head(s) 375 may iteratively refine the predicted surface features 380. Each layer of the transformer may adjust the predicted positions and characteristics of the predicted surface features 380 based on the fused image and LiDAR features, improving the detection accuracy with each iteration. The transformer may output a representation of the predicted surface features 380 in the 3D environment, which may be used by control component(s) of an autonomous vehicle, such as the controller(s) 1336, the ADAS system 1338, and/or an autonomous driving software stack (such as the one described in U.S. Patent Application Publication No. 20210026355A1) executing on one or more components of the vehicle 1300 (e.g., the SoC(s) 1304, the CPU(s) 1318, the GPU(s) 1320, etc.). For example, the parameters predicted by the transformer may be decoded to extract height and/or uncertainty values for each sampled point on the surface, the height and/or uncertainty values may be provided to the control component(s), and the control component(s) may use the height and/or uncertainty values to navigate, plan, or otherwise perform one or more operations (e.g., obstacle or protuberance avoidance, lane keeping, lane changing, merging, splitting, adapting a suspension system of the ego-object or ego-actor to match the current road surface, applying an early acceleration or deceleration based on an approaching surface slope, mapping, etc.) within the environment using any known technique.

Generally, the object detection pipeline 100 of FIG. 1 and/or the surface feature detection pipeline 300 of FIG. 3 may be trained using any suitable loss function to compare predicted output(s) with ground truth. Example loss functions for regression outputs include mean squared error (MSE), mean absolute error (MAE), Huber loss, and smooth L1 loss, and example loss functions for classification outputs include cross-entropy loss, local loss, and hinge loss, to name a few examples. In some embodiments, the object detection pipeline 100 of FIG. 1 and/or the surface feature detection pipeline 300 are trained using one or more auxiliary losses (e.g., based on the output(s) of the auxiliary head 115 and/or 135 of FIG. 1, auxiliary losses 315 and/or 335 of FIG. 3) to help train the image encoder 105 and/or the LiDAR encoder 127. In some scenarios, (e.g., random) initial transformer queries that are located outside the ground truth navigable space may be omitted when training the object detection pipeline 100 (e.g., to avoid training the object detection pipeline 100 on regions predicted to be occupied with static hazards such as potholes or other surface deformities where automatically generated labels may not be reliable). In some embodiments, the object detection pipeline 100 of FIG. 1 and the surface feature detection pipeline 300 of FIG. 3 may be combined into a multitask network with a common transformer decoder and corresponding input and output heads for object and surface feature detection. In some embodiments that implement a multitask network, predicted uncertainties for the two tasks may be used as coefficients for summing their losses during training.

In some embodiments, ground truth data for training a neural network (e.g., the object detection pipeline 100 of FIG. 1, the surface feature detection pipeline 300 of FIG. 3, and/or some other neural network) and/or for parameter tuning of a classical machine learning model that detects objects and/or surface features may be generated in various ways. For example, some embodiments may employ an automated approach (e.g., using classical, non-machine learned algorithms) to derive various types of ground truth data from sensor data collected by one or more data collection vehicles. In an example embodiment, a high degree of automation may be achieved using sensor data from a single LiDAR sensor (e.g., a 360-degree field-of-view, roof-mounted LiDAR scanner), but as a general matter, any number of sensors may be used to collect the underlying sensor data.

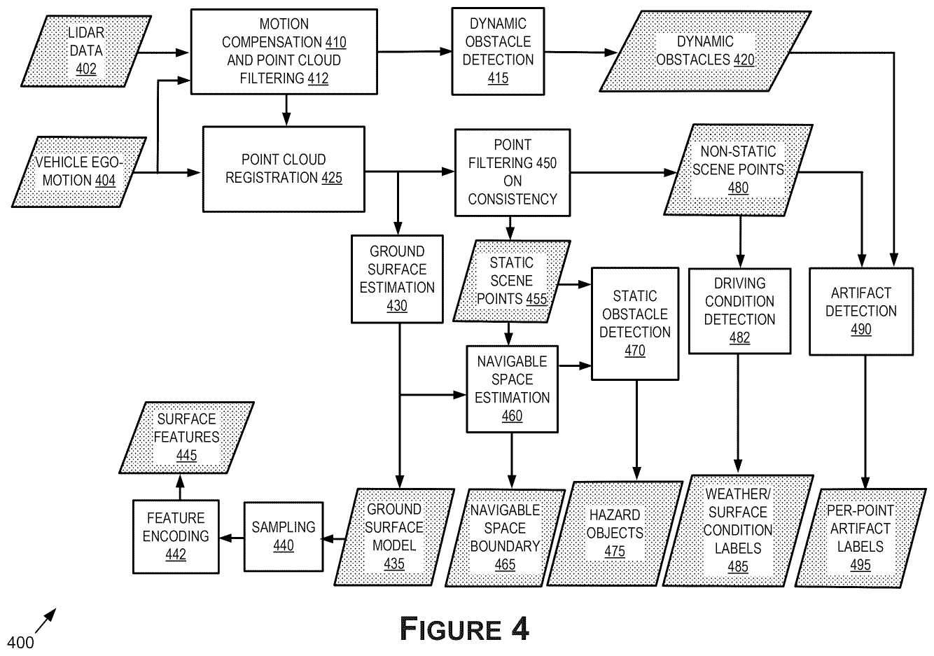

FIG. 4 is a data flow diagram illustrating an example ground truth data generation pipeline 400, in accordance with some embodiments of the present disclosure. Depending on the embodiment, one or more paths through the ground truth data generation pipeline 400 may be used to derive ground truth data such as data representing dynamic obstacle(s) 420, a (e.g., ground) surface model 435, surface feature(s) 445, static scene point(s) 455, a navigable space boundary 465, hazard object(s) 475, non-static scene point(s) 480, weather and/or surface condition label(s) 485, and/or per-point artifact label(s) 495.

In some embodiments, one or more data collection vehicles may be equipped with one or more LiDAR sensors (e.g., a single, roof-mounted, 360° field-of-view LiDAR scanner; a forward-facing, grille-mounted or above-windshield-mounted, long-range LiDAR sensor, etc.), and the LiDAR sensor(s) of the data collection vehicle(s) (and/or a stationary LiDAR sensor) may be used to collect frames of LiDAR data 402 representing various objects (e.g., hazards) and/or surface conditions as the data collection vehicle(s) navigate an environment. In some embodiments that support detection tasks use image data, the data collection vehicle(s) may be equipped with one or more cameras used to collect corresponding frames of image data. Depending on the desired use case for ground truth data, the environment and/or scenario may be selected or designated to cover a range of conditions, terrains, weather situations, times of day, traffic densities, and/or road types to ensure comprehensive data collection. In some cases, target objects and/or surface features may be simulated (e.g., using plywood boards of increasing thickness to mimic step edges in the road surface, and sensor data supporting different detection tasks (e.g., object and surface feature detection) may be collected during the same data collection capture run. The ego-motion 404 of the data collection vehicle(s) may be recorded using any known technique (e.g., using an inertial measurement unit (IMU), global positioning system (GPS), etc.). In some embodiments, LiDAR data collected using (e.g., multiple capture runs by) data collection vehicle(s) with one or more LiDAR sensors may be combined with LiDAR data collected using a stationary 3D (e.g., LiDAR) scanner to improve coverage of the target objects and/or surface features and increase point density in the region(s) of interest. Although some embodiments operate on data collected by a data collection vehicle (e.g., after one or more data capture runs), this need not be the case. For example, any ego-machine (e.g., a production vehicle) may collect LiDAR data (e.g., using a forward-facing, grille-mounted and/or above-windshield-mounted, long-range LiDAR sensor) and execute some or all of the pipeline 400 in real-time to generate any of the data depicted in FIG. 4, whether it is ultimately used as ground truth data, provided in some form to one or more downstream control components of the ego-machine, and/or otherwise.

In some embodiments, motion compensation 410 may be applied to the LiDAR data 402 from any number of LiDAR sensors, data collection runs, and/or spins or scans using the known ego-motion 404 of the data collection vehicle(s) to transform the raw LiDAR range measurements into a common spatial representation (e.g., a frame of aggregated LiDAR data representing a scene in the environment). Additionally or alternatively, point cloud filtering 412 may be used (e.g., on a per-spin basis) to remove points that have an inconsistent range measurement (e.g., beyond a threshold difference) between the first and second return (or, e.g., between the first and strongest return), points flagged as invalid by the LiDAR sensor (e.g., based on the quality or reliability of the return signal), points with a range larger than a designated threshold (e.g., 150 meters), and/or points flagged as a point on an ephemeral (e.g., rain, fog, snow, dust plume) detected using any known technique (e.g., using one or more machine learning model(s)). This preprocessing step may be used to improve the quality of the LiDAR point cloud by removing many artifacts that can have a detrimental effect on downstream operations (e.g., a subsequent point cloud registration).

In some embodiments, dynamic obstacle detection 415 may use any known technique to detect and/or regress the 2D or 3D shape of dynamic obstacles of any designated class represented in the LiDAR data (e.g., point cloud segmentation, projecting the 3D point cloud into a 2D view and then evaluating the resulting 2D projection image, for example, as described in U.S. Pat. No. 11,532,168). Example classes of dynamic obstacles include cars, trucks, buses, motorcycles, pedestrians, cyclists, animals, etc. The LiDAR points that are enclosed by each detected 3D bounding box or other bounding shape (or LiDAR points that project onto each detected 2D bounding box or other bounding shape) may be identified, and may be tracked over a designated number of frames (e.g., three frames) to confirm whether the identified points are moving. If so, the bounding shape may be identified and labeled as a dynamic obstacle, and/or the corresponding points may be identified and labeled as part of a dynamic obstacle. In some embodiments, the dynamic obstacle(s) 420 may be represented using 3D bounding boxes or other bounding shapes describing the extent of each dynamic obstacle, and/or using some or all points contained in the bounding shape. Example uses for the dynamic obstacle(s) 420 include online dynamic obstacle estimation (e.g., training the object detection pipeline 100 of FIG. 1 to detect dynamic obstacles, computing an auxiliary loss such as those described above with respect to the object detection pipeline 100 or the surface feature detection pipeline 300 of FIG. 3).

In some embodiments, detected LiDAR points that belong to dynamic obstacles may be removed, and point cloud registration 425 may be applied to register (e.g., the filtered) point clouds from multiple LiDAR spins or scans to one another to increase point density and generate a refined ego-motion estimate (which supports an increased precision in downstream surface feature estimates). The point cloud registration 425 may use any known technique, such as iterative closest point (ICP), normal distributions transform (NDT), or SLAM.

Estimation of the ground surface is a prerequisite for many tasks in the field of autonomous driving, as an estimated ground surface may be used as a baseline for detecting obstacles on the road surface, may provide an estimate for the drivable area in the vicinity of a vehicle, and/or may serve as a guide for estimating the height of overhanging obstacles. As such, in some embodiments, ground surface estimation 430 may use any known technique to estimate a representation of the ground surface model 435 based on the (e.g., resulting) LiDAR data (e.g., classifying and projecting points predicted to be on the ground surface onto a grid and smoothing projected values, for example, as described in U.S. patent application Ser. No. 17/992,569, Publication No. US20240028041A1) and/or based on image data (e.g., using 3D reconstruction to generate an estimated representation of the ground surface). The ground surface may be defined as a smooth and continuous surface that spans from the vehicle's base or contact point outwards, and the ground surface estimation 430 may focus on estimating a single ground surface model and therefore avoid the ambiguities involved in finding multiple, disjoint surface models. The ground surface model 435 may be defined to cover the same distance range as the LiDAR data (e.g., up to 300 meters) and it may provide a robust estimate for areas that are occluded by certain non-ground objects in the input data (e.g., people, vehicles, and other objects on the road surface). As a result of the ground surface estimation 430, each LiDAR point may be assigned a height above ground. In some embodiments, the heights above ground may be used to extract corresponding curvature estimates by analyzing the variation in height across the points (e.g., fitting a curve or surface to a local patch of points and calculating the rate of change in slope in one or more directions).

In some embodiments, the ground surface estimation 430 may including iteratively refining the accuracy of the ground surface model 435 by minimizing (or approximating minimization of) a cost function that penalizes deviation between measured values and estimated values (the data term) and/or deviations among adjacent measured values (the smoothness term), for example, as described in U.S. patent application Ser. No. 17/992,569. In some scenarios, there may be systematic measurement errors in the measured height values of LiDAR points depending on the range and/or angle of the observed points. As such, to compensate for these measurement errors, weights may be applied to the measurements during the estimation process. For example, LiDAR points with a shorter range, that are observed under a steeper angle, and/or with a smaller beam footprint may be assumed to have a higher accuracy and may therefore be assigned relatively higher weights, and LiDAR points with a longer range, that are observed under a shallower angle, and/or with a larger beam footprint may be assumed to have a lower accuracy and may therefore be assigned relatively lower weights. By incorporating these weights into the cost function during the iterative refinement of the ground surface model 435, the influence of points with higher errors may be reduced, leading to a more accurate and reliable ground surface estimation.

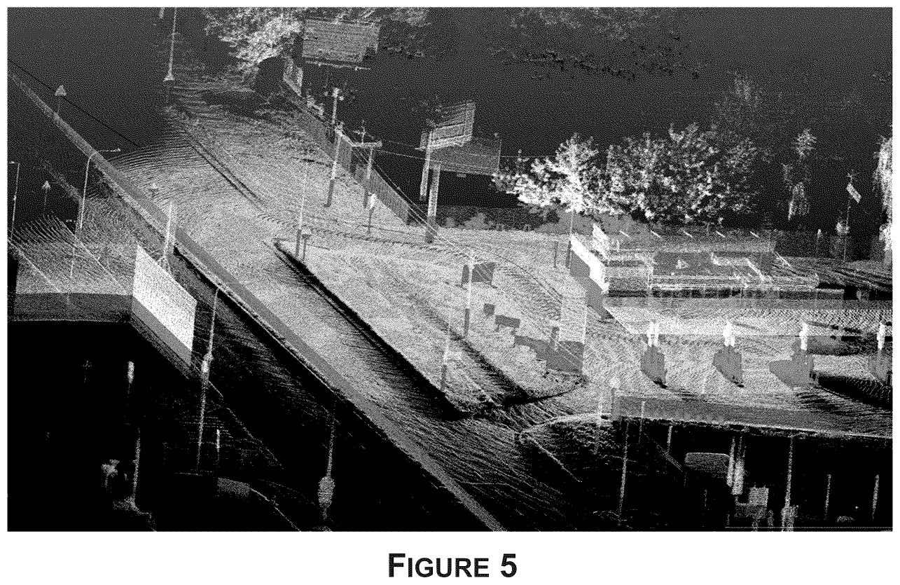

The ground surface model 435 may be represented using a scalar indicating the height above the estimated ground surface for each point on the surface, and/or a regularly spaced grid (e.g., spanning some or all of the scene) with a value for each grid cell encoding the height above ground level (AGL). Example uses for the ground surface model 435 include ground truth for online ground surface estimation, ground truth for sensor self-calibration based on a ground surface observation, and providing per-point classifications of (a) ground points, (b) obstacle points (e.g., 0.1 to 2.5 meters AGL), and/or (c) above head points (e.g., AGL>2.5 meters). FIG. 5 is an illustration of an example ground surface model, in accordance with some embodiments of the present disclosure. More specifically, FIG. 5 illustrates a perspective view of a fused point cloud where points that are higher than 2.5 meters above ground are illustrated with the lightest grey, points on the ground surface model are illustrated with an intermediate shade of grey, and obstacle points up to a height above ground of 2.5 meters are illustrated with the darkest grey.

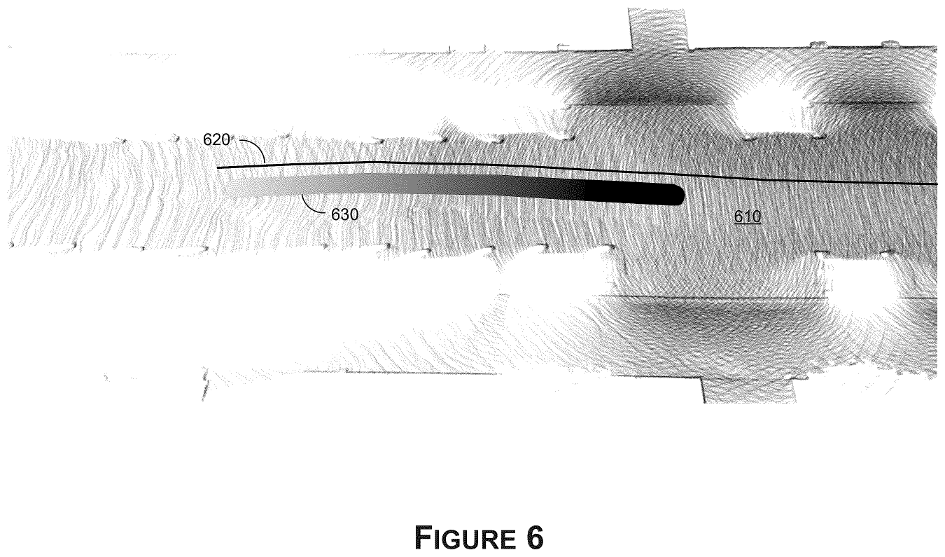

In some embodiments, the ground surface model 435 is used to generate a representation of ground truth surface features 445. Taking an example embodiment involving a surface feature detection network that predicts feature(s) for a designated portion of a ground surface (e.g., a set of points sampled along one or more predicted trajectories), sampling 440 may be applied to sample any number of points from the designated portion of the ground surface model 435. FIG. 6 illustrates an example technique for sampling from a ground surface model, in accordance with some embodiments of the present disclosure. For example, assuming the portion of the ground surface model 610 of interest is an area extending outward from the data collection vehicle along one or more trajectories (e.g., the trajectory 620), one or more segments or sections of points proximate to one or more trajectories on the ground surface model 610 (e.g., region 630) may be selected and sampled for ground truth points. In some embodiments, the selected points in the selected segment(s) or section(s) of the ground surface model 610 may be iteratively refined (e.g., as described above) and used to sample any number of points using any suitable sampling technique. As such, feature encoding 442 may be used to encode the feature(s) of the sampled points that are relevant to the downstream task or use case. The surface feature(s) 445 may be represented using a scalar indicating a corresponding feature (e.g., height, range, a quantified representation of impairment to the surface such as those represented by the surface condition labels 485, surface gradient or curvature, etc.) for each sampled point on the surface, and/or a regularly spaced grid (e.g., spanning some or all of the scene) with one or more values for each grid cell encoding the values for corresponding features. An example use for the surface feature(s) 445 include online surface feature estimation (e.g., by the surface feature detection pipeline 300 of FIG. 3).

In some embodiments, point filtering 450 may be applied to label detected LiDAR points as static or non-static based on consistency over multiple observations. For example, each frame (e.g., spin) of (e.g., filtered) LiDAR data may be used to generate a corresponding projection image (e.g., a range image) by projecting the LiDAR points into a corresponding 2D view. Any given LiDAR point may be projected into the projection images for multiple frames, and a measure of consistency of presence and/or range may be used to classify the point as static or non-static. For example, a measure of presence and/or range consistency may be quantified based on whether a given LiDAR point appears in some threshold number or percentage of frames or spins (e.g., at least 50% of the spins, accounting for occlusions), and/or whether its detected range changes more than some threshold amount even as the sensor moves (e.g., the detected range should not double from frame to frame). In some embodiments, the measure(s) of presence and/or range consistency may be quantified and used to derive a measure of consistency for each LiDAR point, points with a measure of consistency below a designated threshold may be classified as non-static (e.g., a non-static part of the scene), and points with a measure of consistency above the threshold may be classified as static (e.g., part of a static object or a static part of the scene. This is meant simply as an example, and other space carving techniques may be applied in 2D or 3D to iteratively carve out regions in space that are unlikely to contain a static object (and corresponding static points). The static scene point(s) 455 and/or the non-static scene point(s) 480 may be represented using a per-point binary indicator (e.g., flag) assigned to each point in a dataset indicating whether the point is static or non-static. Example uses for the static scene point(s) 455 and/or the non-static scene point(s) 480 include generating a (e.g., watertight) 3D voxel grid representing static occupancy by assigning a binary value to each voxel indicating whether the voxel is occupied (e.g., by a solid object) or unoccupied (empty space).

In some embodiments, navigable space estimation 460 is applied to generate a representation of a navigable (e.g., free) space (e.g., the navigable space boundary 465) using the static scene point(s) 455 and the ground surface model 435. The static scene point(s) 455 likely represent either the ground surface (in which case the height of the point represents the ground height) or a static hazard (in which case the height above ground may be derived from the height of the point and the ground surface model 435). In some embodiments, the ground surface model 435 encodes the ground height (or corresponding range) values. As such, the ground height may be subtracted from the height of each of the static scene point(s) 455 to derive the estimated height above ground for each static scene point. Furthermore, the ground surface model 435 may be represented as a grid with corresponding ground height and surface curvature values. As such, the static scene point(s) 455 may be projected onto the grid, may be aggregated per cell, and may be compensated for noise, and an occupancy grid may be generated by evaluating the resulting height above ground and corresponding estimated surface curvature for each cell using any known height and curvature-based occupancy scoring function. The resulting occupancy scores may be segmented into binary values (e.g., classifying each grid cell as likely occupied or free space) using a global cost minimization technique, and any known technique may be used to extract enclosed 2D contours represented in the resulting binary segmentation map.

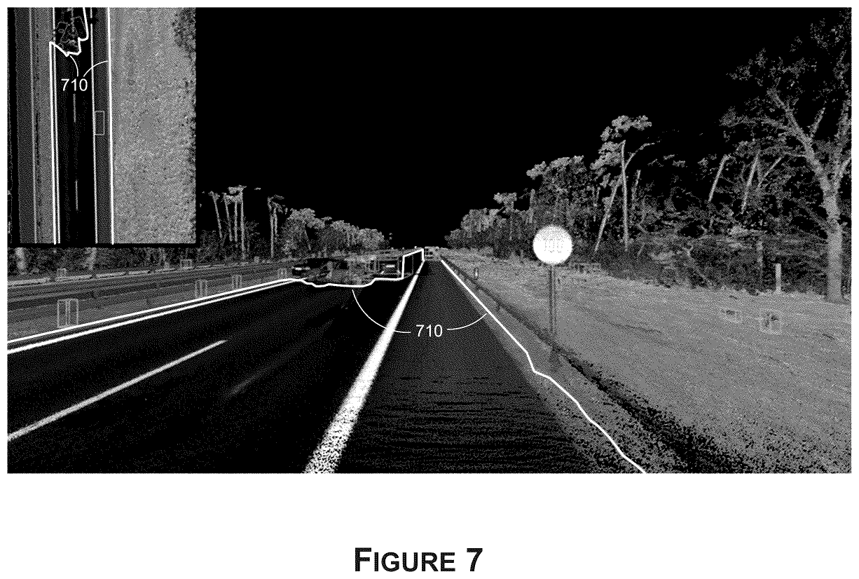

As such, the navigable space estimation 460 may identify the corresponding trajectory of the data collection vehicle, sample a point associated with the trajectory (e.g., a point on the trajectory such as the center point of the trajectory), identify the parent contour of the extracted enclosed 2D contours that encloses the sampled point, and identify that parent contour as the navigable space boundary 465. Additionally or alternatively, the parent contour may be assigned corresponding ground height values (e.g., from the ground surface model 435) to generate a corresponding 3D contour, which may be used as the navigable space boundary 465. In some embodiments, the 3D contour is projected into a corresponding 2D view to generate a 2D boundary for a ground truth segmentation mask, either of which may be used as the navigable space boundary 465. In some embodiments, extracted child contours of the parent contour may be assumed to represent static hazards, assigned corresponding heights, projected into the ground truth segmentation mask, and used to carve out regions from the ground truth navigable space and/or the corresponding navigable space boundary 465. These are just a few examples, and other implementations are possible. In an example embodiment, the navigable space boundary 465 is represented using a time-stamped closed 3D polygon that represents the navigable space associated with a corresponding frame of LiDAR data 402, or a global closed 3D polygon that represents the navigable space for a set of frames of the LiDAR data 402. Example uses for the navigable space boundary 465 include planning and control of an ego-machine during an operational phase (e.g., planning and executing safe paths in real-world scenarios) and geometric pre-filtering of labels to restrict ground truth data to elements located within the navigable space (e.g., omitting random transformer queries that are located outside the ground truth navigable space when training the object detection pipeline 100 of FIG. 1). FIG. 7 is an illustration of an example boundary 710 of a navigable space, in accordance with some embodiments of the present disclosure.

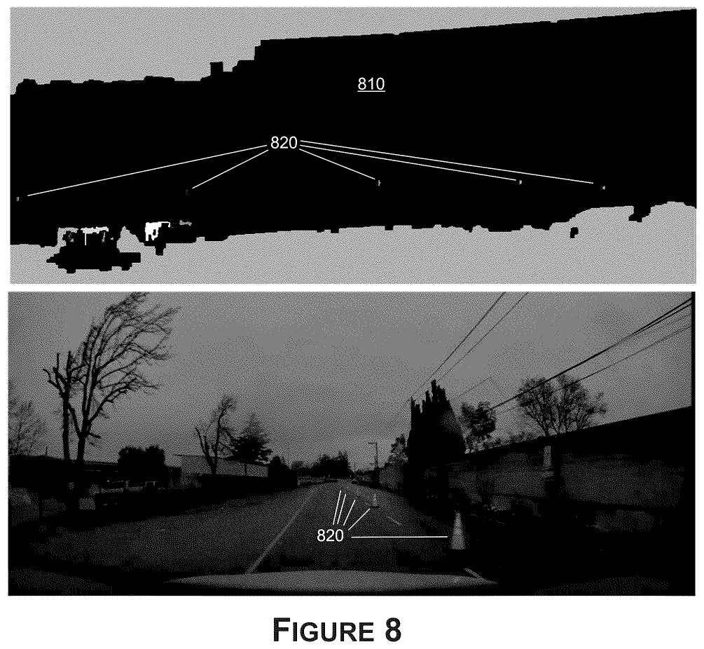

In some embodiments, static obstacle detection 470 may use extracted child contours of the navigable space boundary 465 (e.g., detected contours inside the navigable space that are not part of the navigable space) to identify ground truth hazard objects 475. Depending on the use case and/or the embodiment, extracted child contours that are longer than a designated length and/or that represent or enclose LiDAR points below the ground surface model 435 may be filtered out. The (e.g., remaining) child contours may be assumed to represent static obstacles, and 2D and/or 3D bounding boxes or other bounding shapes may be generated (e.g., using maximum and minimum heights of the LiDAR points enclosed by each contour), and may be used as ground truth hazard object(s) 475. In an example embodiment, the hazard object(s) 475 may be represented using 3D bounding boxes or other bounding shapes describing the extent of each hazard object, and/or using some or all points contained in the bounding shape. Example uses for the hazard object(s) 475 include online static obstacle estimation (e.g., training the object detection pipeline 100 of FIG. 1 to detect static hazards such as road debris), and online weather classification algorithms (e.g., providing annotated environmental data that highlights how obstacle appearances change under different weather conditions). FIG. 8 is an illustration of an example navigable space 810 and example extracted road hazards 820, in accordance with some embodiments of the present disclosure.

In some embodiments that filter out points that belong to the detected dynamic obstacles 420 and identify the remaining non-static scene point(s) 480 in the scene, the non-static scene point(s) 480 are likely to belong to either weather or road conditions like rain or snow in the air or on the ground. As such, in some embodiments, to support weather condition detection tasks, driving condition detection 482 may be applied. For example, the driving condition detection 482 may sample a set of the non-static scene point(s) 480 from a region that is unlikely to contain any obstacles, such as a cube (e.g., one meter in length) or other volume in front of the data collection vehicle and above the ground surface model 435. The non-static scene point(s) 480 detected inside this region may be accumulated (e.g., over some designated duration or number of frames), and the power distribution of the resulting non-static scene point(s) 480 may be quantified across different frequency components (e.g., using a power spectrum analysis). As such, power levels at designated frequencies—or changes in power levels—may be assigned labels representing corresponding types of weather conditions (e.g., rain, snow, fog, dust, clear). Additionally or alternatively, a corresponding level of impairment to visibility may be classified (e.g., using a linear relationship between the number and/or power of non-static scene point(s) 480 and corresponding visibility impairment classes). To support driving condition detection tasks, the driving condition detection 482 may use a similar process to identify and/or accumulate non-static scene point(s) 480 from a region on the ground surface model 435 (e.g., in front of the data collection vehicle), assign labels representing corresponding types of surface conditions (e.g., wet, snowy, icy, damp, dry), and/or assign labels representing corresponding levels of surface impairment.

The weather and/or surface condition label(s) 485 may be represented using one or more labels (e.g., per-point, point scene) representing a ground truth class of weather condition (e.g., rain, snow, fog, dust, clear), a value (e.g., an integer) quantifying impairment to visibility caused by the weather (e.g., from 0 to 4), ground truth class of surface condition (e.g., wet, snowy, icy, damp, dry), a value (e.g., an integer) quantifying impairment to the (e.g., ground) surface caused by the weather or pavement condition (e.g., from 0 to 4), and/or others. Example uses for the weather and/or surface condition label(s) 485 include training online weather and surface (e.g., ground, road, pavement) condition detection or classification algorithms (e.g., as in some embodiments of the surface feature detection network of FIG. 3), detecting when an autonomous vehicle encounters situations or conditions that fall outside the predefined parameters it was designed to handle (its operational design domain or ODD), and data mining for specific weather scenarios.

In some embodiments, artifact detection 490 may identify the non-static scene points 480 an artifact. In some embodiments (e.g., in which points that were identified as part of the dynamic obstacles 420 were not previously filtered out), the artifact detection 490 may subtract those points that belong to the dynamic obstacles 420 from the non-static scene points 480 and label the remaining points as artifacts. The per-point artifact label(s) 495 may be represented using a per-point binary indicator (e.g., flag) assigned to each point in a dataset indicating whether the point belongs to non-solid ephemeral artifacts (e.g., snowflakes, rain drops, dust particles, exhaust or vent plume condensate, etc.) that an ego-machine can navigate through, or a solid surface (e.g., belonging to cars, pedestrians, traffic signs, trees, etc.) that has to be avoided. Example uses for the per-point artifact label(s) 495 include training artifact detection or segmentation algorithms and improving LiDAR simulation of ephemera.

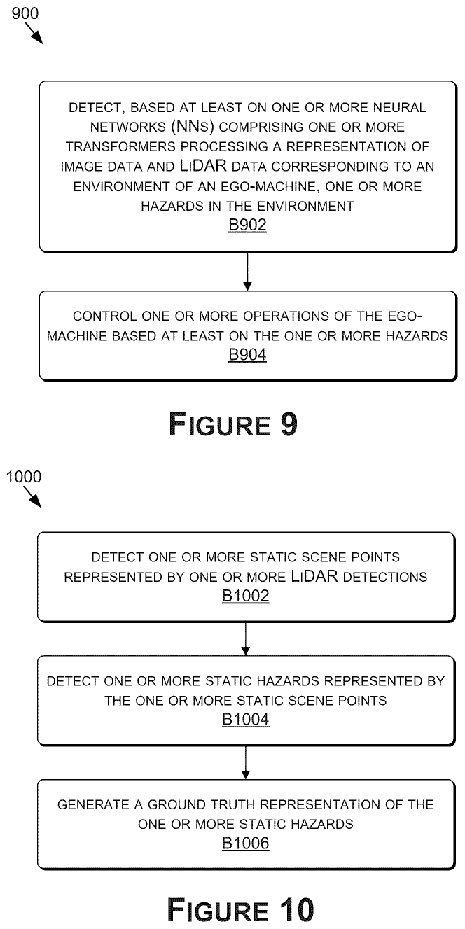

Now referring to FIGS. 9-12, each block of methods 900-1200, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods may be described, by way of example, with respect to the object detection pipeline 100 of FIG. 1, the surface feature detection pipeline 300 of FIG. 3, or the ground truth data generation pipeline 400 of FIG. 4. However, these methods may additionally or alternatively be executed by any one system, or any combination of systems, including, but not limited to, those described herein.

FIG. 9 is a flow diagram illustrating a method 900 for hazard detection, in accordance with some embodiments of the present disclosure. The method 900, at block B902, includes detecting, based at least on one or more neural networks (NNs) comprising one or more transformers processing a representation of image data and LiDAR data corresponding to an environment of an ego-machine, one or more hazards in the environment. For example, in the embodiment illustrated in FIG. 1, the object detection pipeline 100 uses image data 101 and LiDAR data 121 (e.g., generated using corresponding sensors of an ego-machine such as the autonomous vehicle 1300 of FIGS. 13A-13D) to detect bounding shapes 180 and/or other features of objects of one or more designated classes in the environment. More specifically, the query generator 140 may generate a set of object queries 145 comprising a set of reference or anchor 3D locations using candidate bounding shapes predicted from extracted image features 110 by the auxiliary head 115 and/or predicted from extracted LiDAR features 130 by the auxiliary head 135, using randomly initialized 3D locations, and/or using (e.g., the top K) ego-motion compensated transformer predictions (e.g., for objects predicted with a threshold confidence) from a previous frame. The feature sampler 150 may sample the image features 110 (e.g., in perspective view) and/or the LiDAR features 130 (e.g., in top-down or bird's eye view) around each 3D reference point at keypoint locations identified by projecting learned (e.g., deformable) and/or designated 2D or 3D offsets into corresponding feature maps, and a transformer (e.g., comprising the input layer(s) 165, the transformer decoder 170, and the output head(s) 175) may use the sampled image and LiDAR features to extract a representation of whether there is an object (e.g., a hazard) at the 3D location corresponding to each of the object queries 145, its shape, and/or its class.

The method 900, at block B904, includes controlling one or more operations of the ego-machine based at least on the one or more hazards. For example, with respect to the object detection pipeline 100 of FIG. 1, the output head(s) 175 of the transformer may output a representation of the predicted locations, sizes, and/or classes of detected objects in the 3D environment. The object detections may be used by control component(s) of an autonomous vehicle, such as the controller(s) 1336, the ADAS system 1338, and/or an autonomous driving software stack (such as the one described in U.S. Patent Application Publication No. 20210026355A1) executing on one or more components of the vehicle 1300 (e.g., the SoC(s) 1304, the CPU(s) 1318, the GPU(s) 1320, etc.). For example, the parameters predicted by the transformer may be decoded to generate 3D bounding boxes or other bounding shapes 180 and corresponding class labels and confidences, these object detections may be provided to the control component(s), and the control component(s) may use the object detections navigate, plan, or otherwise perform one or more operations (e.g., obstacle avoidance, lane keeping, lane changing, merging, splitting, etc.) within the environment using any known technique.

FIG. 10 is a flow diagram illustrating a method 1000 for generating a ground truth representation of one or more static hazards, in accordance with some embodiments of the present disclosure. The method 1000, at block B1002, includes detecting one or more static scene points represented by one or more LiDAR detections. For example, with respect to the ground truth data generation pipeline 400 of FIG. 4, point filtering 450 may be applied to label detected LiDAR points as static or non-static based on consistency over multiple observations. In some embodiments, space carving may be applied in 2D or 3D to iteratively carve out regions in space that are unlikely to contain a static object (and corresponding static points). For example, measure(s) of presence and/or range consistency may be quantified and used to derive a measure of consistency for each LiDAR point, points with a measure of consistency below a designated threshold may be classified as non-static (e.g., a non-static part of the scene), and points with a measure of consistency above the threshold may be classified as static (e.g., part of a static object or a static part of the scene.

The method 1000, at block B1004, includes detecting one or more static hazards represented by the one or more static scene points. For example, with respect to the ground truth data generation pipeline 400 of FIG. 4, as part of navigable space estimation 460 or static obstacle detection 470, the static scene point(s) 455 may be projected onto a grid representation of the ground surface model 435, may be aggregated per cell, and may be compensated for noise, and an occupancy grid may be generated by evaluating the resulting height above ground and corresponding estimated surface curvature for each cell using any known height and curvature-based occupancy scoring function. The resulting occupancy scores may be segmented into binary values (e.g., classifying each grid cell as likely occupied or free space) using a global cost minimization technique, and any known technique may be used to extract enclosed 2D contours represented in the resulting binary segmentation map. The parent contour of the extracted enclosed 2D contours that encloses one or more points on the trajectory of the ego-machine may be identified as the navigable space boundary 465, and the extracted child contours of the navigable space boundary 465 may be used to identify the ground truth hazard objects 475. Depending on the use case and/or the embodiment, extracted child contours that are longer than a designated length and/or that represent or enclose LiDAR points below the ground surface model 435 may be filtered out. The (e.g., remaining) child contours may be assumed to represent static obstacles.

The method 1000, at block B1006, includes generating a ground truth representation of the one or more static hazards. For example, with respect to the ground truth data generation pipeline 400 of FIG. 4, 2D and/or 3D bounding boxes or other bounding shapes may be generated (e.g., using maximum and minimum heights of the LiDAR points enclosed by each contour), and may be used as ground truth hazard object(s) 475. In an example embodiment, the hazard object(s) 475 may be represented using 3D bounding boxes or other bounding shapes describing the extent of each hazard object, and/or using some or all points contained in the bounding shape.

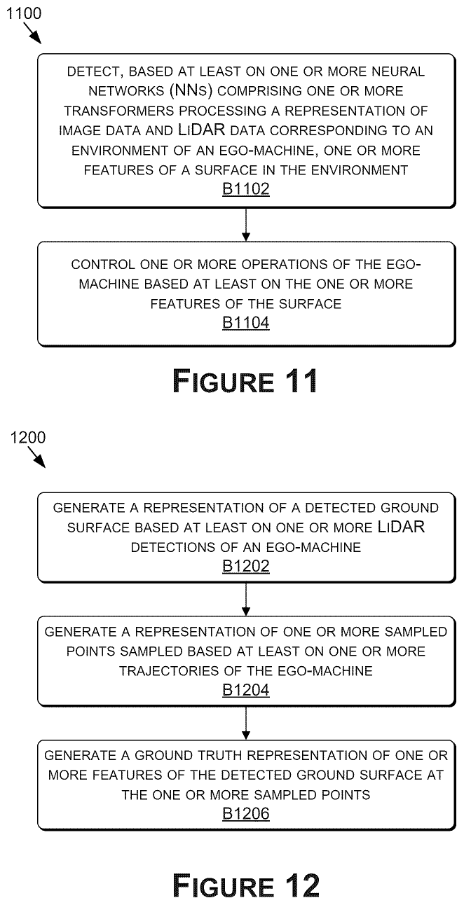

FIG. 11 is a flow diagram illustrating a method 1100 for surface feature detection, in accordance with some embodiments of the present disclosure. The method 1100, at block B1102, includes detecting, based at least on one or more neural networks (NNs) comprising one or more transformers processing a representation of image data and LiDAR data corresponding to an environment of an ego-machine, one or more features of a surface in the environment. For example, the surface feature detection pipeline 300 may be used to detect one or more features of the road or other surface in the environment. More specifically, the query generator 340 may generate a set of surface queries 345 using one or more trajectories of the ego-machine (e.g., one or more tire trajectories) predicted by the path generator 350 based on the corresponding wheel angle 337 and/or ego-motion compensated transformer predictions (e.g., for surface locations predicted with a threshold confidence) from a previous frame. As such, a transformer formed by the input layer(s) 365, the transformer decoder 370, and the output head(s) 375 may use sampled image and LiDAR features to extract a representation of the surface feature(s) 380 (e.g., height, range, driving condition, etc.) at the 3D location corresponding to each of the surface queries, and the surface queries 345 representing candidate 3D locations on the surface may be iteratively refined to detect one or more profiles of the surface.

The method 1100, at block B1104 includes controlling one or more operations of the ego-machine based at least on the one or more features of the surface. For example, with respect to the surface feature detection pipeline 300 of FIG. 3, The output head(s) 375 of the transformer may output a representation of the predicted surface features 380 in the 3D environment, which may be used by control component(s) of an autonomous vehicle, such as the controller(s) 1336, the ADAS system 1338, and/or an autonomous driving software stack (such as the one described in U.S. Patent Application Publication No. 20210026355A1) executing on one or more components of the vehicle 1300 (e.g., the SoC(s) 1304, the CPU(s) 1318, the GPU(s) 1320, etc.). For example, the parameters predicted by the transformer may be decoded to extract height and/or uncertainty values for each sampled point on the surface, the height and/or uncertainty values may be provided to the control component(s), and the control component(s) may use the height and/or uncertainty values to navigate, plan, or otherwise perform one or more operations (e.g., obstacle or protuberance avoidance, lane keeping, lane changing, merging, splitting, adapting a suspension system of the ego-object or ego-actor to match the current road surface, applying an early acceleration or deceleration based on an approaching surface slope, mapping, etc.) within the environment using any known technique.

FIG. 12 is a flow diagram illustrating a method 1200 for generating a ground truth representation of one or more features of a detected ground surface, in accordance with some embodiments of the present disclosure. The method 1200, at block B1202, includes generating a representation of a detected ground surface based at least on one or more LiDAR detections of an ego-machine. For example, with respect to the ground truth data generation pipeline 400 of FIG. 4, ground surface estimation 430 may use any known technique to estimate a representation of the ground surface model 435 based on the (e.g., accumulated, ego-motion compensated, filtered) LiDAR data (e.g., classifying and projecting points predicted to be on the ground surface onto a grid and smoothing projected values, for example, as described in U.S. patent application Ser. No. 17/992,569) and/or based on image data (e.g., using 3D reconstruction to generate an estimated representation of the ground surface). In some embodiments, the ground surface estimation 430 may including iteratively refining the accuracy of the ground surface model 435 by minimizing (or approximating minimization of) a cost function that penalizes deviation between measured values and estimated values (the data term) and/or deviations among adjacent measured values.

The method 1200, at block B1204, includes generating a representation of one or more sampled points sampled based at least on one or more trajectories of the ego-machine. For example, with respect to the ground truth data generation pipeline 400 of FIG. 4, and taking an example embodiment involving a surface feature detection network that predicts feature(s) for a designated portion of a ground surface (e.g., a set of points sampled along one or more predicted trajectories), sampling 440 may be applied to sample any number of points from the designated portion of the ground surface model 435. With respect to FIG. 6, assuming the portion of the ground surface model 610 of interest is an area extending outward from a data collection vehicle along one or more known trajectories (e.g., the trajectory 620), one or more segments or sections of points proximate to one or more trajectories on the ground surface model 610 (e.g., region 630) may be selected and sampled for ground truth points. In some embodiments, the selected points in the selected segment(s) or section(s) of the ground surface model 610 may be iteratively refined (e.g., as described above) and used to sample any number of points using any suitable sampling technique.

The method 1200, at block B1206, includes generating a ground truth representation of one or more features of the detected ground surface at the one or more sampled points. For example, with respect to the ground truth data generation pipeline 400 of FIG. 4, feature encoding 442 may be used to encode the feature(s) of the sampled points that are relevant to a desired downstream task or use case. The surface feature(s) 445 may be represented using a scalar indicating a corresponding feature (e.g., height, range, a quantified representation of impairment to the surface such as those represented by the surface condition labels 485, surface gradient or curvature, etc.) for each sampled point on the surface, and/or a regularly spaced grid (e.g., spanning some or all of the scene) with one or more values for each grid cell encoding the values for corresponding features.

The systems and methods described herein may be used by—or may be used in combination with—without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

For example, the present techniques (e.g., the object detection pipeline 100 of FIG. 1, the surface feature detection pipeline 300 of FIG. 3, the ground truth data generation pipeline 400 of FIG. 4, some portion thereof, etc.) may be used in various robotics implementations (e.g., by a robot navigating a surface or objects in a warehouse), may be used within a simulation such as NVIDIA DRIVE Sim™ (e.g., using virtual sensors and/or ray-tracing to generate simulated input data corresponding to one or more of the components described herein, using real and/or simulated input data to generate simulated ground truth data, using real and/or simulated data to train or validate a neural network such as those described herein or a classical machine learning model, etc.), and/or otherwise. Generally, a simulation may be used to create simulated datasets that replicate various real-world conditions (e.g., that may be difficult or dangerous to observe in the real world), and training or validating a neural network or classical machine learning model within a simulation may expose these models to a range of (e.g., rare or dangerous) scenarios in a controlled and safe environment.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets, systems implemented at least partially using cloud computing resources, and/or other types of systems.

### Example Autonomous Vehicle

FIG. 13A is an illustration of an example autonomous vehicle 1300, in accordance with some embodiments of the present disclosure. The autonomous vehicle 1300 (alternatively referred to herein as the “vehicle 1300”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1300 may be capable of functionality in accordance with one or more of Level 3-Level 5 of the autonomous driving levels. The vehicle 1300 may be capable of functionality in accordance with one or more of Level 1-Level 5 of the autonomous driving levels. For example, the vehicle 1300 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1300 or other machine, such as being fully autonomous, being highly autonomous, being conditionally autonomous, being partially autonomous, providing assistive autonomy, being semi-autonomous, being primarily autonomous, or other designation.

The vehicle 1300 may include components such as a chassis, a vehicle body, wheels (e.g., 2, 4, 6, 8, 18, etc.), tires, axles, and other components of a vehicle. The vehicle 1300 may include a propulsion system 1350, such as an internal combustion engine, hybrid electric power plant, an all-electric engine, and/or another propulsion system type. The propulsion system 1350 may be connected to a drive train of the vehicle 1300, which may include a transmission, to allow the propulsion of the vehicle 1300. The propulsion system 1350 may be controlled in response to receiving signals from the throttle/accelerator 1352.

A steering system 1354, which may include a steering wheel, may be used to steer the vehicle 1300 (e.g., along a desired path or route) when the propulsion system 1350 is operating (e.g., when the vehicle is in motion). The steering system 1354 may receive signals from a steering actuator 1356. The steering wheel may be optional for full automation (Level 5) functionality.

The brake sensor system 1346 may be used to operate the vehicle brakes in response to receiving signals from the brake actuators 1348 and/or brake sensors.

Controller(s) 1336, which may include one or more system on chips (SoCs) 1304 (FIG. 13C) and/or GPU(s), may provide signals (e.g., representative of commands) to one or more components and/or systems of the vehicle 1300. For example, the controller(s) may send signals to operate the vehicle brakes via one or more brake actuators 1348, to operate the steering system 1354 via one or more steering actuators 1356, to operate the propulsion system 1350 via one or more throttle/accelerators 1352. The controller(s) 1336 may include one or more onboard (e.g., integrated) computing devices (e.g., supercomputers) that process sensor signals, and output operation commands (e.g., signals representing commands) to allow autonomous driving and/or to assist a human driver in driving the vehicle 1300. The controller(s) 1336 may include a first controller 1336 for autonomous driving functions, a second controller 1336 for functional safety functions, a third controller 1336 for artificial intelligence functionality (e.g., computer vision), a fourth controller 1336 for infotainment functionality, a fifth controller 1336 for redundancy in emergency conditions, and/or other controllers. In some examples, a single controller 1336 may handle two or more of the above functionalities, two or more controllers 1336 may handle a single functionality, and/or any combination thereof.

The controller(s) 1336 may provide the signals for controlling one or more components and/or systems of the vehicle 1300 in response to sensor data received from one or more sensors (e.g., sensor inputs). The sensor data may be received from, for example and without limitation, global navigation satellite systems (“GNSS”) sensor(s) 1358 (e.g., Global Positioning System sensor(s)), RADAR sensor(s) 1360, ultrasonic sensor(s) 1362, LiDAR sensor(s) 1364, inertial measurement unit (IMU) sensor(s) 1366 (e.g., accelerometer(s), gyroscope(s), magnetic compass(es), magnetometer(s), etc.), microphone(s) 1396, stereo camera(s) 1368, wide-view camera(s) 1370 (e.g., fisheye cameras), infrared camera(s) 1372, surround camera(s) 1374 (e.g., 360 degree cameras), long-range and/or mid-range camera(s) 1398, speed sensor(s) 1344 (e.g., for measuring the speed of the vehicle 1300), vibration sensor(s) 1342, steering sensor(s) 1340, brake sensor(s) (e.g., as part of the brake sensor system 1346), one or more occupant monitoring system (OMS) sensor(s) 1301 (e.g., one or more interior cameras), and/or other sensor types.

One or more of the controller(s) 1336 may receive inputs (e.g., represented by input data) from an instrument cluster 1332 of the vehicle 1300 and provide outputs (e.g., represented by output data, display data, etc.) via a human-machine interface (HMI) display 1334, an audible annunciator, a loudspeaker, and/or via other components of the vehicle 1300. The outputs may include information such as vehicle velocity, speed, time, map data (e.g., the High Definition (“HD”) map 1322 of FIG. 13C), location data (e.g., the vehicle's 1300 location, such as on a map), direction, location of other vehicles (e.g., an occupancy grid), information about objects and status of objects as perceived by the controller(s) 1336, etc. For example, the HMI display 1334 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1300 further includes a network interface 1324 which may use one or more wireless antenna(s) 1326 and/or modem(s) to communicate over one or more networks. For example, the network interface 1324 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1326 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 13B is an example of camera locations and fields of view for the example autonomous vehicle 1300 of FIG. 13A, in accordance with some embodiments of the present disclosure. The cameras and respective fields of view are one example embodiment and are not intended to be limiting. For example, additional and/or alternative cameras may be included and/or the cameras may be located at different locations on the vehicle 1300.

The camera types for the cameras may include, but are not limited to, digital cameras that may be adapted for use with the components and/or systems of the vehicle 1300. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1300 (e.g., front-facing cameras) may be used for surround view, to help identify forward facing paths and obstacles, as well aid in, with the help of one or more controllers 1336 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1370 that may be used to perceive objects coming into view from the periphery (e.g., pedestrians, crossing traffic or bicycles). Although only one wide-view camera is illustrated in FIG. 13B, there may be any number (including zero) of wide-view cameras 1370 on the vehicle 1300. In addition, any number of long-range camera(s) 1398 (e.g., a long-view stereo camera pair) may be used for depth-based object detection, especially for objects for which a neural network has not yet been trained. The long-range camera(s) 1398 may also be used for object detection and classification, as well as basic object tracking.

Any number of stereo cameras 1368 may also be included in a front-facing configuration. In at least one embodiment, one or more of stereo camera(s) 1368 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1368 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1368 may be used in addition to, or alternatively from, those described herein.

Cameras with a field of view that include portions of the environment to the side of the vehicle 1300 (e.g., side-view cameras) may be used for surround view, providing information used to create and update the occupancy grid, as well as to generate side impact collision warnings. For example, surround camera(s) 1374 (e.g., four surround cameras 1374 as illustrated in FIG. 13B) may be positioned to on the vehicle 1300. The surround camera(s) 1374 may include wide-view camera(s) 1370, fisheye camera(s), 360 degree camera(s), and/or the like. Four example, four fisheye cameras may be positioned on the vehicle's front, rear, and sides. In an alternative arrangement, the vehicle may use three surround camera(s) 1374 (e.g., left, right, and rear), and may leverage one or more other camera(s) (e.g., a forward-facing camera) as a fourth surround view camera.

Cameras with a field of view that include portions of the environment to the rear of the vehicle 1300 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1398, stereo camera(s) 1368), infrared camera(s) 1372, etc.), as described herein.

Cameras with a field of view that include portions of the interior environment within the cabin of the vehicle 1300 (e.g., one or more OMS sensor(s) 1301) may be used as part of an occupant monitoring system (OMS) such as, but not limited to, a driver monitoring system (DMS). For example, OMS sensors (e.g., the OMS sensor(s) 1301) may be used (e.g., by the controller(s) 1336) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 13C is a block diagram of an example system architecture for the example autonomous vehicle 1300 of FIG. 13A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1300 in FIG. 13C are illustrated as being connected via bus 1302. The bus 1302 may include a Controller Area Network (CAN) data interface (alternatively referred to herein as a “CAN bus”). A CAN may be a network inside the vehicle 1300 used to aid in control of various features and functionality of the vehicle 1300, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1302 is described herein as being a CAN bus, this is not intended to be limiting. For example, in addition to, or alternatively from, the CAN bus, FlexRay and/or Ethernet may be used. Additionally, although a single line is used to represent the bus 1302, this is not intended to be limiting. For example, there may be any number of busses 1302, which may include one or more CAN busses, one or more FlexRay busses, one or more Ethernet busses, and/or one or more other types of busses using a different protocol. In some examples, two or more busses 1302 may be used to perform different functions, and/or may be used for redundancy. For example, a first bus 1302 may be used for collision avoidance functionality and a second bus 1302 may be used for actuation control. In any example, each bus 1302 may communicate with any of the components of the vehicle 1300, and two or more busses 1302 may communicate with the same components. In some examples, each SoC 1304, each controller 1336, and/or each computer within the vehicle may have access to the same input data (e.g., inputs from sensors of the vehicle 1300), and may be connected to a common bus, such the CAN bus.

The vehicle 1300 may include one or more controller(s) 1336, such as those described herein with respect to FIG. 13A. The controller(s) 1336 may be used for a variety of functions. The controller(s) 1336 may be coupled to any of the various other components and systems of the vehicle 1300, and may be used for control of the vehicle 1300, artificial intelligence of the vehicle 1300, infotainment for the vehicle 1300, and/or the like.

The vehicle 1300 may include a system(s) on a chip (SoC) 1304. The SoC 1304 may include CPU(s) 1306, GPU(s) 1308, processor(s) 1310, cache(s) 1312, accelerator(s) 1314, data store(s) 1316, and/or other components and features not illustrated. The SoC(s) 1304 may be used to control the vehicle 1300 in a variety of platforms and systems. For example, the SoC(s) 1304 may be combined in a system (e.g., the system of the vehicle 1300) with an HD map 1322 which may obtain map refreshes and/or updates via a network interface 1324 from one or more servers (e.g., server(s) 1378 of FIG. 13D).

The CPU(s) 1306 may include a CPU cluster or CPU complex (alternatively referred to herein as a “CCPLEX”). The CPU(s) 1306 may include multiple cores and/or L2 caches. For example, in some embodiments, the CPU(s) 1306 may include eight cores in a coherent multi-processor configuration. In some embodiments, the CPU(s) 1306 may include four dual-core clusters where each cluster has a dedicated L2 cache (e.g., a 2 MB L2 cache). The CPU(s) 1306 (e.g., the CCPLEX) may be configured to support simultaneous cluster operation allowing any combination of the clusters of the CPU(s) 1306 to be active at any given time.

The CPU(s) 1306 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1306 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1308 may include an integrated GPU (alternatively referred to herein as an “iGPU”). The GPU(s) 1308 may be programmable and may be efficient for parallel workloads. The GPU(s) 1308, in some examples, may use an enhanced tensor instruction set. The GPU(s) 1308 may include one or more streaming microprocessors, where each streaming microprocessor may include an L1 cache (e.g., an L1 cache with at least 96KB storage capacity), and two or more of the streaming microprocessors may share an L2 cache (e.g., an L2 cache with a 512 KB storage capacity). In some embodiments, the GPU(s) 1308 may include at least eight streaming microprocessors. The GPU(s) 1308 may use compute application programming interface(s) (API(s)). In addition, the GPU(s) 1308 may use one or more parallel computing platforms and/or programming models (e.g., NVIDIA's CUDA).

The GPU(s) 1308 may be power-optimized for best performance in automotive and embedded use cases. For example, the GPU(s) 1308 may be fabricated on a Fin field-effect transistor (FinFET). However, this is not intended to be limiting and the GPU(s) 1308 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 1308 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1308 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1308 to access the CPU(s) 1306 page tables directly. In such examples, when the GPU(s) 1308 memory management unit (MMU) experiences a miss, an address translation request may be transmitted to the CPU(s) 1306. In response, the CPU(s) 1306 may look in its page tables for the virtual-to-physical mapping for the address and transmits the translation back to the GPU(s) 1308. As such, unified memory technology may allow a single unified virtual address space for memory of both the CPU(s) 1306 and the GPU(s) 1308, thereby simplifying the GPU(s) 1308 programming and porting of applications to the GPU(s) 1308.

In addition, the GPU(s) 1308 may include an access counter that may keep track of the frequency of access of the GPU(s) 1308 to memory of other processors. The access counter may help ensure that memory pages are moved to the physical memory of the processor that is accessing the pages most frequently.

The SoC(s) 1304 may include any number of cache(s) 1312, including those described herein. For example, the cache(s) 1312 may include an L3 cache that is available to both the CPU(s) 1306 and the GPU(s) 1308 (e.g., that is connected both the CPU(s) 1306 and the GPU(s) 1308). The cache(s) 1312 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1304 may include an arithmetic logic unit(s) (ALU(s)) which may be leveraged in performing processing with respect to any of the variety of tasks or operations of the vehicle 1300—such as processing DNNs. In addition, the SoC(s) 1304 may include a floating point unit(s) (FPU(s))—or other math coprocessor or numeric coprocessor types—for performing mathematical operations within the system. For example, the SoC(s) 1304 may include one or more FPUs integrated as execution units within a CPU(s) 1306 and/or GPU(s) 1308.

The SoC(s) 1304 may include one or more accelerators 1314 (e.g., hardware accelerators, software accelerators, or a combination thereof). For example, the SoC(s) 1304 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 1308 and to off-load some of the tasks of the GPU(s) 1308 (e.g., to free up more cycles of the GPU(s) 1308 for performing other tasks). As an example, the accelerator(s) 1314 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1314 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1308, and by using an inference accelerator, for example, a designer may target either the DLA(s) or the GPU(s) 1308 for any function. For example, the designer may focus processing of CNNs and floating point operations on the DLA(s) and leave other functions to the GPU(s) 1308 and/or other accelerator(s) 1314.

The accelerator(s) 1314 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 1306. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1314 (e.g., the hardware acceleration cluster) may include a computer vision network on-chip and SRAM, for providing a high-bandwidth, low latency SRAM for the accelerator(s) 1314. In some examples, the on-chip memory may include at least 4MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1304 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1314 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1366 output that correlates with the vehicle 1300 orientation, distance, 3D location estimates of the object obtained from the neural network and/or other sensors (e.g., LiDAR sensor(s) 1364 or RADAR sensor(s) 1360), among others.

The SoC(s) 1304 may include data store(s) 1316 (e.g., memory). The data store(s) 1316 may be on-chip memory of the SoC(s) 1304, which may store neural networks to be executed on the GPU and/or the DLA. In some examples, the data store(s) 1316 may be large enough in capacity to store multiple instances of neural networks for redundancy and safety. The data store(s) 1316 may comprise L2 or L3 cache(s) 1312. Reference to the data store(s) 1316 may include reference to the memory associated with the PVA, DLA, and/or other accelerator(s) 1314, as described herein.

The SoC(s) 1304 may include one or more processor(s) 1310 (e.g., embedded processors). The processor(s) 1310 may include a boot and power management processor that may be a dedicated processor and subsystem to handle boot power and management functions and related security enforcement. The boot and power management processor may be a part of the SoC(s) 1304 boot sequence and may provide runtime power management services. The boot power and management processor may provide clock and voltage programming, assistance in system low power state transitions, management of SoC(s) 1304 thermals and temperature sensors, and/or management of the SoC(s) 1304 power states. Each temperature sensor may be implemented as a ring-oscillator whose output frequency is proportional to temperature, and the SoC(s) 1304 may use the ring-oscillators to detect temperatures of the CPU(s) 1306, GPU(s) 1308, and/or accelerator(s) 1314. If temperatures are determined to exceed a threshold, the boot and power management processor may enter a temperature fault routine and put the SoC(s) 1304 into a lower power state and/or put the vehicle 1300 into a chauffeur to safe stop mode (e.g., bring the vehicle 1300 to a safe stop).

The processor(s) 1310 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1310 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1310 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1310 may further include a real-time camera engine that may include a dedicated processor subsystem for handling real-time camera management.

The processor(s) 1310 may further include a high-dynamic range signal processor that may include an image signal processor that is a hardware engine that is part of the camera processing pipeline.

The processor(s) 1310 may include a video image compositor that may be a processing block (e.g., implemented on a microprocessor) that implements video post-processing functions needed by a video playback application to produce the final image for the player window. The video image compositor may perform lens distortion correction on wide-view camera(s) 1370, surround camera(s) 1374, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1308 is not required to continuously render new surfaces. Even when the GPU(s) 1308 is powered on and active doing 3D rendering, the video image compositor may be used to offload the GPU(s) 1308 to improve performance and responsiveness.

The SoC(s) 1304 may further include a mobile industry processor interface (MIPI) camera serial interface for receiving video and input from cameras, a high-speed interface, and/or a video input block that may be used for camera and related pixel input functions. The SoC(s) 1304 may further include an input/output controller(s) that may be controlled by software and may be used for receiving I/O signals that are uncommitted to a specific role.

The SoC(s) 1304 may further include a broad range of peripheral interfaces to allow communication with peripherals, audio codecs, power management, and/or other devices. The SoC(s) 1304 may be used to process data from cameras (e.g., connected over Gigabit Multimedia Serial Link and Ethernet), sensors (e.g., LiDAR sensor(s) 1364, RADAR sensor(s) 1360, etc. that may be connected over Ethernet), data from bus 1302 (e.g., speed of vehicle 1300, steering wheel position, etc.), data from GNSS sensor(s) 1358 (e.g., connected over Ethernet or CAN bus). The SoC(s) 1304 may further include dedicated high-performance mass storage controllers that may include their own DMA engines, and that may be used to free the CPU(s) 1306 from routine data management tasks.

The SoC(s) 1304 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1304 may be faster, more reliable, and even more energy-efficient and space-efficient than conventional systems. For example, the accelerator(s) 1314, when combined with the CPU(s) 1306, the GPU(s) 1308, and the data store(s) 1316, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 1320) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1308.

In some examples, a CNN for facial recognition and vehicle owner identification may use data from camera sensors to identify the presence of an authorized driver and/or owner of the vehicle 1300. The always on sensor processing engine may be used to unlock the vehicle when the owner approaches the driver door and turn on the lights, and, in security mode, to disable the vehicle when the owner leaves the vehicle. In this way, the SoC(s) 1304 provide for security against theft and/or carjacking.

In another example, a CNN for emergency vehicle detection and identification may use data from microphones 1396 to detect and identify emergency vehicle sirens. In contrast to conventional systems, that use general classifiers to detect sirens and manually extract features, the SoC(s) 1304 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1358. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1362, until the emergency vehicle(s) passes.

The vehicle may include a CPU(s) 1318 (e.g., discrete CPU(s), or dCPU(s)), that may be coupled to the SoC(s) 1304 via a high-speed interconnect (e.g., PCIe). The CPU(s) 1318 may include an X86 processor, for example. The CPU(s) 1318 may be used to perform any of a variety of functions, including arbitrating potentially inconsistent results between ADAS sensors and the SoC(s) 1304, and/or monitoring the status and health of the controller(s) 1336 and/or infotainment SoC 1330, for example.

The vehicle 1300 may include a GPU(s) 1320 (e.g., discrete GPU(s), or dGPU(s)), that may be coupled to the SoC(s) 1304 via a high-speed interconnect (e.g., NVIDIA's NVLINK). The GPU(s) 1320 may provide additional artificial intelligence functionality, such as by executing redundant and/or different neural networks, and may be used to train and/or update neural networks based on input (e.g., sensor data) from sensors of the vehicle 1300.

The vehicle 1300 may further include the network interface 1324 which may include one or more wireless antennas 1326 (e.g., one or more wireless antennas for different communication protocols, such as a cellular antenna, a Bluetooth antenna, etc.). The network interface 1324 may be used to allow wireless connectivity over the Internet with the cloud (e.g., with the server(s) 1378 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1300 information about vehicles in proximity to the vehicle 1300 (e.g., vehicles in front of, on the side of, and/or behind the vehicle 1300). This functionality may be part of a cooperative adaptive cruise control functionality of the vehicle 1300.

The network interface 1324 may include a SoC that provides modulation and demodulation functionality and enables the controller(s) 1336 to communicate over wireless networks. The network interface 1324 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1300 may further include data store(s) 1328 which may include off-chip (e.g., off the SoC(s) 1304) storage. The data store(s) 1328 may include one or more storage elements including RAM, SRAM, DRAM, VRAM, Flash, hard disks, and/or other components and/or devices that may store at least one bit of data.

The vehicle 1300 may further include GNSS sensor(s) 1358. The GNSS sensor(s) 1358 (e.g., GPS, assisted GPS sensors, differential GPS (DGPS) sensors, etc.), to assist in mapping, perception, occupancy grid generation, and/or path planning functions. Any number of GNSS sensor(s) 1358 may be used, including, for example and without limitation, a GPS using a USB connector with an Ethernet to Serial (RS-232) bridge.

The vehicle 1300 may further include RADAR sensor(s) 1360. The RADAR sensor(s) 1360 may be used by the vehicle 1300 for long-range vehicle detection, even in darkness and/or severe weather conditions. RADAR functional safety levels may be ASIL B. The RADAR sensor(s) 1360 may use the CAN and/or the bus 1302 (e.g., to transmit data generated using the RADAR sensor(s) 1360) for control and to access object tracking data, with access to Ethernet to access raw data in some examples. A wide variety of RADAR sensor types may be used. For example, and without limitation, the RADAR sensor(s) 1360 may be suitable for front, rear, and side RADAR use. In some example, Pulse Doppler RADAR sensor(s) are used.

The RADAR sensor(s) 1360 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1360 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1300 surroundings at higher speeds with minimal interference from traffic in adjacent lanes. The other two antennae may expand the field of view, making it possible to quickly detect vehicles entering or leaving the vehicle's 1300 lane.

Mid-range RADAR systems may include, as an example, a range of up to 1360 m (front) or 80 m (rear), and a field of view of up to 42 degrees (front) or 1350 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1300 may further include ultrasonic sensor(s) 1362. The ultrasonic sensor(s) 1362, which may be positioned at the front, back, and/or the sides of the vehicle 1300, may be used for park assist and/or to create and update an occupancy grid. A wide variety of ultrasonic sensor(s) 1362 may be used, and different ultrasonic sensor(s) 1362 may be used for different ranges of detection (e.g., 2.5 m, 4 m). The ultrasonic sensor(s) 1362 may operate at functional safety levels of ASIL B.

The vehicle 1300 may include LiDAR sensor(s) 1364. The LiDAR sensor(s) 1364 may be used for object and pedestrian detection, emergency braking, collision avoidance, and/or other functions. The LiDAR sensor(s) 1364 may be functional safety level ASIL B. In some examples, the vehicle 1300 may include multiple LiDAR sensors 1364 (e.g., two, four, six, etc.) that may use Ethernet (e.g., to provide data to a Gigabit Ethernet switch).

In some examples, the LiDAR sensor(s) 1364 may be capable of providing a list of objects and their distances for a 360-degree field of view. Commercially available LiDAR sensor(s) 1364 may have an advertised range of approximately 1300 m, with an accuracy of 2 cm-3 cm, and with support for a 1300 Mbps Ethernet connection, for example. In some examples, one or more non-protruding LiDAR sensors 1364 may be used. In such examples, the LiDAR sensor(s) 1364 may be implemented as a small device that may be embedded into the front, rear, sides, and/or corners of the vehicle 1300. The LiDAR sensor(s) 1364, in such examples, may provide up to a 120-degree horizontal and 35-degree vertical field-of-view, with a 200 m range even for low-reflectivity objects. Front-mounted LiDAR sensor(s) 1364 may be configured for a horizontal field of view between 45 degrees and 135 degrees. FIG. 13B illustrates example long-range and short-range horizontal fields-of-view for a LiDAR sensor 1364 with an example mounting location above the windshield, but other configurations such as those that include a grille-mounted LiDAR sensor 1364 (e.g., as illustrated in FIG. 13A) and/or a roof-mounted LiDAR scanner (e.g., for a data collection vehicle) are possible.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1300. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1364 may be less susceptible to motion blur, vibration, and/or shock.

The vehicle may further include IMU sensor(s) 1366. The IMU sensor(s) 1366 may be located at a center of the rear axle of the vehicle 1300, in some examples. The IMU sensor(s) 1366 may include, for example and without limitation, an accelerometer(s), a magnetometer(s), a gyroscope(s), a magnetic compass(es), and/or other sensor types. In some examples, such as in six-axis applications, the IMU sensor(s) 1366 may include accelerometers and gyroscopes, while in nine-axis applications, the IMU sensor(s) 1366 may include accelerometers, gyroscopes, and magnetometers.

In some embodiments, the IMU sensor(s) 1366 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1366 may allow the vehicle 1300 to estimate heading without requiring input from a magnetic sensor by directly observing and correlating the changes in velocity from GPS to the IMU sensor(s) 1366. In some examples, the IMU sensor(s) 1366 and the GNSS sensor(s) 1358 may be combined in a single integrated unit.

The vehicle may include microphone(s) 1396 placed in and/or around the vehicle 1300. The microphone(s) 1396 may be used for emergency vehicle detection and identification, among other things.

The vehicle may further include any number of camera types, including stereo camera(s) 1368, wide-view camera(s) 1370, infrared camera(s) 1372, surround camera(s) 1374, long-range and/or mid-range camera(s) 1398, and/or other camera types. The cameras may be used to capture image data around an entire periphery of the vehicle 1300. The types of cameras used depends on the embodiments and requirements for the vehicle 1300, and any combination of camera types may be used to provide the necessary coverage around the vehicle 1300. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 13A and FIG. 13B.

The vehicle 1300 may further include vibration sensor(s) 1342. The vibration sensor(s) 1342 may measure vibrations of components of the vehicle, such as the axle(s). For example, changes in vibrations may indicate a change in road surfaces. In another example, when two or more vibration sensors 1342 are used, the differences between the vibrations may be used to determine friction or slippage of the road surface (e.g., when the difference in vibration is between a power-driven axle and a freely rotating axle).

The vehicle 1300 may include an ADAS system 1338. The ADAS system 1338 may include a SoC, in some examples. The ADAS system 1338 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1360, LiDAR sensor(s) 1364, and/or a camera(s). The ACC systems may include longitudinal ACC and/or lateral ACC. Longitudinal ACC monitors and controls the distance to the vehicle immediately ahead of the vehicle 1300 and automatically adjust the vehicle speed to maintain a safe distance from vehicles ahead. Lateral ACC performs distance keeping, and advises the vehicle 1300 to change lanes when necessary. Lateral ACC is related to other ADAS applications such as LCA and CWS.

CACC uses information from other vehicles that may be received via the network interface 1324 and/or the wireless antenna(s) 1326 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1300), while the I2V communication concept provides information about traffic further ahead. CACC systems may include either or both I2V and V2V information sources. Given the information of the vehicles ahead of the vehicle 1300, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1360, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1360, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1300 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1300 if the vehicle 1300 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1360, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1300 is backing up. Some RCTW systems include AEB to ensure that the vehicle brakes are applied to avoid a crash. RCTW systems may use one or more rear-facing RADAR sensor(s) 1360, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1300, the vehicle 1300 itself must, in the case of conflicting results, decide whether to heed the result from a primary computer or a secondary computer (e.g., a first controller 1336 or a second controller 1336). For example, in some embodiments, the ADAS system 1338 may be a backup and/or secondary computer for providing perception information to a backup computer rationality module. The backup computer rationality monitor may run a redundant diverse software on hardware components to detect faults in perception and dynamic driving tasks. Outputs from the ADAS system 1338 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1304.

In other examples, ADAS system 1338 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1338 may be fed into the primary computer's perception block and/or the primary computer's dynamic driving task block. For example, if the ADAS system 1338 indicates a forward crash warning due to an object immediately ahead, the perception block may use this information when identifying objects. In other examples, the secondary computer may have its own neural network which is trained and thus reduces the risk of false positives, as described herein.

The vehicle 1300 may further include the infotainment SoC 1330 (e.g., an in-vehicle infotainment system (IVI)). Although illustrated and described as a SoC, the infotainment system may not be a SoC, and may include two or more discrete components. The infotainment SoC 1330 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1300. For example, the infotainment SoC 1330 may radios, disk players, navigation systems, video players, USB and Bluetooth connectivity, carputers, in-car entertainment, Wi-Fi, steering wheel audio controls, hands free voice control, a heads-up display (HUD), an HMI display 1334, a telematics device, a control panel (e.g., for controlling and/or interacting with various components, features, and/or systems), and/or other components. The infotainment SoC 1330 may further be used to provide information (e.g., visual and/or audible) to a user(s) of the vehicle, such as information from the ADAS system 1338, autonomous driving information such as planned vehicle maneuvers, trajectories, surrounding environment information (e.g., intersection information, vehicle information, road information, etc.), and/or other information.

The infotainment SoC 1330 may include GPU functionality. The infotainment SoC 1330 may communicate over the bus 1302 (e.g., CAN bus, Ethernet, etc.) with other devices, systems, and/or components of the vehicle 1300. In some examples, the infotainment SoC 1330 may be coupled to a supervisory MCU such that the GPU of the infotainment system may perform some self-driving functions in the event that the primary controller(s) 1336 (e.g., the primary and/or backup computers of the vehicle 1300) fail. In such an example, the infotainment SoC 1330 may put the vehicle 1300 into a chauffeur to safe stop mode, as described herein.

The vehicle 1300 may further include an instrument cluster 1332 (e.g., a digital dash, an electronic instrument cluster, a digital instrument panel, etc.). The instrument cluster 1332 may include a controller and/or supercomputer (e.g., a discrete controller or supercomputer). The instrument cluster 1332 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1330 and the instrument cluster 1332. As such, the instrument cluster 1332 may be included as part of the infotainment SoC 1330, or vice versa.

FIG. 13D is a system diagram for communication between cloud-based server(s) and the example autonomous vehicle 1300 of FIG. 13A, in accordance with some embodiments of the present disclosure. The system 1376 may include server(s) 1378, network(s) 1390, and vehicles, including the vehicle 1300. The server(s) 1378 may include a plurality of GPUs 1384(A)-1384(H) (collectively referred to herein as GPUs 1384), PCIe switches 1382(A)-1382(D) (collectively referred to herein as PCIe switches 1382), and/or CPUs 1380(A)-1380(B) (collectively referred to herein as CPUs 1380). The GPUs 1384, the CPUs 1380, and the PCIe switches may be interconnected with high-speed interconnects such as, for example and without limitation, NVLink interfaces 1388 developed by NVIDIA and/or PCIe connections 1386. In some examples, the GPUs 1384 are connected via NVLink and/or NVSwitch SoC and the GPUs 1384 and the PCIe switches 1382 are connected via PCIe interconnects. Although eight GPUs 1384, two CPUs 1380, and two PCIe switches are illustrated, this is not intended to be limiting. Depending on the embodiment, each of the server(s) 1378 may include any number of GPUs 1384, CPUs 1380, and/or PCIe switches. For example, the server(s) 1378 may each include eight, sixteen, thirty-two, and/or more GPUs 1384.

The server(s) 1378 may receive, over the network(s) 1390 and from the vehicles, image data representative of images showing unexpected or changed road conditions, such as recently commenced road-work. The server(s) 1378 may transmit, over the network(s) 1390 and to the vehicles, neural networks 1392, updated neural networks 1392, and/or map information 1394, including information regarding traffic and road conditions. The updates to the map information 1394 may include updates for the HD map 1322, such as information regarding construction sites, potholes, detours, flooding, and/or other obstructions. In some examples, the neural networks 1392, the updated neural networks 1392, and/or the map information 1394 may have resulted from new training and/or experiences represented in data received from any number of vehicles in the environment, and/or based on training performed at a datacenter (e.g., using the server(s) 1378 and/or other servers).

The server(s) 1378 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1390, and/or the machine learning models may be used by the server(s) 1378 to remotely monitor the vehicles.

In some examples, the server(s) 1378 may receive data from the vehicles and apply the data to up-to-date real-time neural networks for real-time intelligent inferencing. The server(s) 1378 may include deep-learning supercomputers and/or dedicated AI computers powered by GPU(s) 1384, such as a DGX and DGX Station machines developed by NVIDIA. However, in some examples, the server(s) 1378 may include deep learning infrastructure that use only CPU-powered datacenters.

The deep-learning infrastructure of the server(s) 1378 may be capable of fast, real-time inferencing, and may use that capability to evaluate and verify the health of the processors, software, and/or associated hardware in the vehicle 1300. For example, the deep-learning infrastructure may receive periodic updates from the vehicle 1300, such as a sequence of images and/or objects that the vehicle 1300 has located in that sequence of images (e.g., via computer vision and/or other machine learning object classification techniques). The deep-learning infrastructure may run its own neural network to identify the objects and compare them with the objects identified by the vehicle 1300 and, if the results do not match and the infrastructure concludes that the AI in the vehicle 1300 is malfunctioning, the server(s) 1378 may transmit a signal to the vehicle 1300 instructing a fail-safe computer of the vehicle 1300 to assume control, notify the passengers, and complete a safe parking maneuver.

For inferencing, the server(s) 1378 may include the GPU(s) 1384 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). As such, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that allow the computing device 1400 to communicate with other computing devices via an electronic communication network, included wired and/or wireless communications. The communication interface 1410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may allow the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that allow detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to allow the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Data Center

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1533, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may use distributed file system 1538 for large-scale data processing (e.g., “big data”). In at least one embodiment, job scheduler 1533 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1533. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:
Clause 1. One or more processors comprising processing circuitry to detect, based at least on one or more neural networks (NNs) comprising one or more transformers processing a representation of image data and LiDAR data corresponding to an environment of an ego-machine, one or more hazards in the environment.
Clause 2. The one or more processors of clause 1, wherein the processing circuitry is further to control one or more operations of the ego-machine based at least on the one or more hazards.
Clause 3. The one or more processors of clause 1 or 2, wherein the processing the representation of the image data comprises generating one or more three-dimensional transformer queries based at least on one or more two-dimensional candidate bounding shapes extracted from the image data using the one or more NNs, and applying one or more sampled two-dimensional image features extracted from the image data using the one or more NNs to the one or more transformers.
Clause 4. The one or more processors of clause 1 or 2, wherein the processing the representation of the LiDAR data comprises generating one or more three-dimensional transformer queries based at least on one or more two-dimensional candidate bounding shapes extracted from the LiDAR data using the one or more NNs, and applying one or more sampled two-dimensional LiDAR features extracted from the LiDAR data using the one or more NNs to the one or more transformers.
Clause 5. The one or more processors of clause 1 or 2, wherein the processing the representation of the image data and the LiDAR data comprises fusing one or more sampled two-dimensional image features and one or more sampled two-dimensional LiDAR features using one or more cross-attention layers of the one or more transformers.
Clause 6. The one or more processors of clause 1 or 2, wherein the processing the representation of the image data and the LiDAR data comprises projecting one or more keypoints associated with one or more reference three-dimensional positions corresponding to one or more transformer queries into extracted image features and extracted LiDAR features.
Clause 7. The one or more processors of clause 1 or 2, wherein the processing circuitry is further to generate a plurality of transformer queries based at least on one or more candidate bounding shapes extracted from the image data or the LiDAR data, one or more randomly initialized three-dimensional positions and one or more ego-motion compensated transformer predictions.
Clause 8. The one or more processors of clause 1 or 2, wherein the processing circuitry is further to detect the one or more hazards based at least on the one or more transformers: generating classification data representing whether there is road debris predicted at a three-dimensional location corresponding to each transformer query of one or more transformer queries, and regressing a representation of a bounding shape of the road debris at the three-dimensional location.
Clause 9. The one or more processors of clause 1 or 2, wherein the processing circuitry is further to update the one or more transformers based at least on omitting transformer queries representing reference three-dimensional locations outside a ground truth navigable space.
Clause 10. The one or more processors of clause 1 or 2, wherein the processing circuitry is further to navigate the ego-machine based at least on avoiding or compensating for the one or more hazards.
Clause 11. The one or more processors of clause 1 or 2, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system incorporating one or more virtual machines (VMs); a system implemented at least partially in a data center; or a system implemented at least partially using cloud computing resources.
Clause 12. A system comprising one or more processors to control one or more operations of an ego-machine in an environment based at least on one or more hazards, the one or more hazards detected based at least on one or more neural networks (NNs) comprising one or more transformers processing a representation of image data and LiDAR data corresponding to the environment.
Clause 13. A method comprising detecting one or more static scene points represented by one or more LiDAR detections.
Clause 14. The method of clause 13, further comprising detecting one or more static hazards represented by the one or more static scene points.
Clause 15. The method of clause 13 or 14, further comprising generating a ground truth representation of the one or more static hazards.
Clause 16. The method of clause 13, 14 or 15, wherein the detecting of the one or more static scene points is based at least on a measure of consistency of at least one of presence or range of the one or more LiDAR detections in a set of projection images.
Clause 17. The method of clause 13, 14 or 15, wherein the detecting of the one or more static scene points comprises filtering out one or more non-static points from the one or more LiDAR detections.
Clause 18. The method of clause 13, 14 or 15, further comprising detecting the one or more static hazards based at least on evaluating, using a height and curvature-based occupancy scoring function, the one or more static scene points and a ground truth ground surface detected from the one or more LiDAR detections.
Clause 19. The method of clause 13, 14 or 15, further comprising detecting the one or more static hazards based at least on segmenting an occupancy grid generated based at least on a ground truth ground surface detected from the one or more LiDAR detections and the one or more static scene points.
Clause 20. The method of clause 13, 14 or 15, further comprising detecting the one or more static hazards based at least on extracting one or more contours from a segmented occupancy map.
Clause 21. The method of clause 13, 14 or 15, further comprising detecting the one or more static hazards based at least on extracting, from a segmented occupancy map, one or more child contours of a parent contour representing a predicted ground truth navigable space.
Clause 22. The method of clause 13, 14 or 15, wherein the generating of the ground truth representation of the one or more static hazards is based at least on associating a range of height values corresponding to a set of the LiDAR detections enclosed by each two-dimensional contour of one or more extracted two-dimensional contours representing the one or more static hazards.
Clause 23. The method of clause 13, 14 or 15, further comprising detecting a representation of a ground truth navigable space based at least on evaluating the one or more static scene points and a ground truth ground surface detected from the one or more LiDAR detections.
Clause 24. The method of clause 13, 14 or 15, further comprising updating one or more static hazard detection networks based at least on the ground truth representation of the one or more static hazards.
Clause 25. The method of clause 13, 14 or 15, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system incorporating one or more virtual machines (VMs); a system implemented at least partially in a data center; or a system implemented at least partially using cloud computing resources.
Clause 26. One or more processors comprising processing circuitry to detect, based at least on one or more neural networks (NNs) comprising one or more transformers processing a representation of image data and LiDAR data corresponding to an environment of an ego-machine, one or more features of a surface in the environment.
Clause 27. The one or more processors of clause 26, wherein the processing circuitry is further to control one or more operations of the ego-machine based at least on the one or more features of the surface.
Clause 28. The one or more processors of clause 26 or 27, wherein the circuitry is further to generate a plurality of three-dimensional transformer queries based at least on one or more sampled points on the surface and one or more ego-motion compensated transformer predictions.
Clause 29. The one or more processors of clause 26 or 27, wherein the circuitry is further to generate one or more three-dimensional transformer queries representing one or more three-dimensional locations based at least on one or more trajectories of the ego-machine.
Clause 30. The one or more processors of clause 26 or 27, wherein the circuitry is further to generate one or more three-dimensional transformer queries representing one or more three-dimensional locations based at least on logarithmically sampling one or more trajectories of the ego-machine.
Clause 31. The one or more processors of clause 26 or 27, wherein the processing of the representation of the image data and the LiDAR data comprises refining one or more initial heights of the surface represented by one or more initial three-dimensional transformer queries based at least on fusing one or more sampled two-dimensional image features and one or more sampled two-dimensional LiDAR features in one or more cross-attention layers of the one or more transformers.
Clause 32. The one or more processors of clause 26 or 27, wherein the circuitry is further to project one or more keypoints associated with one or more reference three-dimensional positions corresponding to one or more transformer queries representing one or more initial heights of the surface into extracted image features and extracted LiDAR features.
Clause 33. The one or more processors of clause 26 or 27, wherein the circuitry is further to detect the one or more features of the surface based at least on the one or more transformers: regressing a representation of one or more height values of one or more sampled points of the surface corresponding to each transformer query of one or more transformer queries.
Clause 34. The one or more processors of clause 26 or 27, wherein the one or more NNs form a multitask network comprising a first transformer output head that regresses one or more surface profiles of the surface and a second transformer output head that regresses one or more bounding shapes of detected road debris on the surface.
Clause 35. The one or more processors of clause 26 or 27, wherein the one or more operations comprise at least one of: avoiding one or more detected protuberances represented by the one or more features of the surface, adapting a suspension of the ego-machine based at least on a surface profile represented by the one or more features of the surface, or applying an early acceleration or deceleration based at least on an approaching surface slope represented by the one or more features of the surface.
Clause 36. The one or more processors of clause 26 or 27, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system incorporating one or more virtual machines (VMs); a system implemented at least partially in a data center; or a system implemented at least partially using cloud computing resources.
Clause 37. A system comprising one or more processors to control one or more operations of an ego-machine based at least on one or more features of a surface in an environment, the one or more features detected based at least on one or more neural networks (NNs) comprising one or more transformers processing a representation of image data and LiDAR data corresponding to the environment.
Clause 38. The system of clause 37, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system incorporating one or more virtual machines (VMs); a system implemented at least partially in a data center; or a system implemented at least partially using cloud computing resources.
Clause 39. A method comprising generating a representation of a detected ground surface based at least on one or more LiDAR detections of an ego-machine.
Clause 40. The method of clause 39, further comprising generating a representation of one or more sampled points sampled based at least on one or more trajectories of the ego-machine.
Clause 41. The method of clause 39 or 40, further comprising generating a ground truth representation of one or more features of the detected ground surface at the one or more sampled points.
Clause 42. The method of clause 39, 40 or 41, further comprising accumulating the one or more LiDAR detections of the detected ground surface using one or more stationary LiDAR sensors and one or more LiDAR sensors of one or more data collection vehicles.
Clause 43. The method of clause 39, 40 or 41, further comprising applying smoothing to a region of the detected ground surface comprising the one or more trajectories of the ego-machine prior to sampling the one or more sampled points from the region of the detected ground surface.
Clause 44. The method of clause 39, 40 or 41, wherein the one or more features of the detected ground surface comprise one or more detected heights of the detected ground surface.
Clause 45. The method of clause 39, 40 or 41, further comprising associating one or more labels representing one or more detected ground truth weather conditions with one or more frames of the one or more LiDAR detections based at least on a power distribution of a set of non-static scene points detected from the one or more LiDAR detections in a designated volume.
Clause 46. The method of clause 39, 40 or 41, further comprising associating one or more labels representing one or more detected ground truth surface conditions with one or more frames of the one or more LiDAR detections based at least on a power distribution of a set of non-static scene points detected from the one or more LiDAR detections in a designated region of the detected ground surface.
Clause 47. The method of clause 39, 40 or 41, further comprising generating one or more surface profile detection networks based at least on the ground truth representation of the one or more features of the detected ground surface at the one or more sampled points.
Clause 48. The method of clause 39, 40 or 41, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system incorporating one or more virtual machines (VMs); a system implemented at least partially in a data center; or a system implemented at least partially using cloud computing resources.

What is claimed is:

1. A method comprising:
generating a representation of a detected ground surface based at least on one or more LiDAR detections of an ego-machine;
generating a representation of one or more sampled points sampled based at least on one or more trajectories of the ego-machine; and
generating a ground truth representation of one or more features of the detected ground surface at the one or more sampled points.

2. The method of claim 1, further comprising accumulating the one or more LiDAR detections of the detected ground surface using one or more stationary LiDAR sensors and one or more LiDAR sensors of one or more data collection vehicles.

3. The method of claim 1, further comprising applying smoothing to a region of the detected ground surface comprising the one or more trajectories of the ego-machine prior to sampling the one or more sampled points from the region of the detected ground surface.

4. The method of claim 1, wherein the one or more features of the detected ground surface comprise one or more detected heights of the detected ground surface.

5. The method of claim 1, further comprising associating one or more labels representing one or more detected ground truth weather conditions with one or more frames of the one or more LiDAR detections based at least on a power distribution of a set of non-static scene points detected from the one or more LiDAR detections in a designated volume.

6. The method of claim 1, further comprising associating one or more labels representing one or more detected ground truth surface conditions with one or more frames of the one or more LiDAR detections based at least on a power distribution of a set of non-static scene points detected from the one or more LiDAR detections in a designated region of the detected ground surface.

7. The method of claim 1, further comprising generating one or more surface profile detection networks based at least on the ground truth representation of the one or more features of the detected ground surface at the one or more sampled points.

8. The method of claim 1, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system incorporating one or more virtual machines (VMs);
a system implemented at least partially in a data center; or
a system implemented at least partially using cloud computing resources.

9. A system comprising one or more processors to generate a ground truth representation of one or more features of a detected ground surface, corresponding to one or more LiDAR detections of an ego-machine, at one or more sampled points sampled based at least on one or more trajectories of the ego-machine.

10. The system of claim 9, wherein the one or more processors are further to accumulate the one or more LiDAR detections of the detected ground surface using one or more stationary LiDAR sensors and one or more LiDAR sensors of one or more data collection vehicles.

11. The system of claim 9, wherein the one or more processors are further to apply smoothing to a region of the detected ground surface comprising the one or more trajectories of the ego-machine prior to sampling the one or more sampled points from the region of the detected ground surface.

12. The system of claim 9, wherein the one or more features of the detected ground surface comprise one or more detected heights of the detected ground surface.

13. One or more processors comprising processing circuitry to:
generate a representation of a detected ground surface based at least on one or more LiDAR detections corresponding to one or more data collection machines;
generate a representation of one or more sampled points sampled based at least on one or more trajectories of the one or more data collection machines; and
generate a ground truth representation of one or more features of the detected ground surface at the one or more sampled points.

14. The one or more processors of claim 13, wherein the processing circuitry is further to accumulate the one or more LiDAR detections of the detected ground surface using one or more stationary LiDAR sensors and one or more LiDAR sensors of the one or more data collection machines.

15. The one or more processors of claim 13, wherein the processing circuitry is further to apply smoothing to a region of the detected ground surface comprising the one or more trajectories of the one or more data collection machines prior to sampling the one or more sampled points from the region of the detected ground surface.

16. The one or more processors of claim 13, wherein the one or more features of the detected ground surface comprise one or more detected heights of the detected ground surface.

17. The one or more processors of claim 13, wherein the processing circuitry is further to associate one or more labels representing one or more detected ground truth weather conditions with one or more frames of the one or more LiDAR detections based at least on a power distribution of a set of non-static scene points detected from the one or more LiDAR detections in a designated volume.

18. The one or more processors of claim 13, wherein the processing circuitry is further to associate one or more labels representing one or more detected ground truth surface conditions with one or more frames of the one or more LiDAR detections based at least on a power distribution of a set of non-static scene points detected from the one or more LiDAR detections in a designated region of the detected ground surface.

19. The one or more processors of claim 13, wherein the processing circuitry is further to generate one or more surface profile detection networks based at least on the ground truth representation of the one or more features of the detected ground surface at the one or more sampled points.

20. The one or more processors of claim 13, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system incorporating one or more virtual machines (VMs);
a system implemented at least partially in a data center; or
a system implemented at least partially using cloud computing resources.
